(19) United States
(12) Patent Application Publication
(10) Pub. No.: US 2026/0245558 A1
(43) Pub. Date: Aug. 20, 2026

(54) INFORMATION PROCESSING DEVICE, INFORMATION PROCESSING METHOD, AND PROGRAM

(71) Applicant: Sony Group Corporation, Tokyo (JP)

(72) Inventor: Yuri SATO, Tokyo (JP)

(73) Assignee: Sony Group Corporation, Tokyo (JP)

(21) Appl. No.: 19/161,576

(22) PCT Filed: Feb. 29, 2024
(86) PCT No.: PCT/JP2024/007491

§ 371 Date: Sep. 2, 2025

(30) Foreign Application Priority Data
Mar. 24, 2023 (JP) 2023-048288

(51) Int. Cl. G10L 15/26; G06F 40/103; G06F 40/166; G06Q 10/109; G09B 5/02; G10L 25/51

(52) U.S. Cl. CPC G10L 15/26; G06F 40/103; G06F 40/166; G06Q 10/109; G10L 25/51; G09B 5/02

(57) ABSTRACT

There is provided an information processing device, an information processing method, and a program capable of more appropriately outputting information obtained from a dialogue. The information processing device includes: an analysis unit that analyzes input data regarding a dialogue between multiple speakers; a master generation unit that generates master data serving as a source for generating output data regarding the dialogue on the basis of an analysis result of the input data; an evaluation generation unit that generates evaluation data obtained by evaluating the master data on the basis of evaluation metrics set in accordance with a speaker; a summary generation unit that generates summary data representing at least one of the master data or the evaluation data in a format indicated by format information on the basis of preset format information; and a filter unit that extracts, from the summary data, disclosure information data corresponding to information in a disclosable range designated by level information on the basis of the level information set in accordance with a viewer, and outputs the output data based on the extracted disclosure information data.

### TECHNICAL FIELD

The present disclosure relates to an information processing device, an information processing method, and a program, and more particularly, to an information processing device, an information processing method, and a program capable of more appropriately outputting information obtained from a dialogue.

### BACKGROUND ART

Conventionally, there is a technology for acquiring and analyzing utterance audio of a participant in a class, a meeting, or the like, and presenting useful information based on an analysis result (See, for example, Patent Document 1).

Patent Document 1 discloses a technology for sequentially analyzing audio captured by a microphone during a meeting to extract one or more words/phrases from the utterance of a participant, collecting information related to the extracted words/phrases from the Internet to acquire knowledge, generating support information for supporting the ideas of the participant or progress of the meeting using the acquired knowledge, and outputting the support information via synthesized audio.

### CITATION LIST

### Patent Document

Patent Document 1: Japanese Patent Application Laid-Open No. 2021-56829

### SUMMARY OF THE INVENTION

### Problems to be Solved by the Invention

However, in the conventional technology including the technology disclosed in Patent Document 1, since information obtained from a dialogue including utterances exchanged between participants is output without any restrictions, there is a case where appropriate output is not performed for each viewer of information. Therefore, there has been a demand for a technology for appropriately outputting information obtained from the dialogue for each viewer of information.

The present disclosure has been made in view of such circumstances, and makes it possible to more appropriately output information obtained from a dialogue.

### SOLUTIONS TO PROBLEMS

According to an aspect of the present disclosure, there is provided an information processing device including: an analysis unit that analyzes input data regarding a dialogue between multiple speakers; a master generation unit that generates master data serving as a source for generating output data regarding the dialogue on the basis of an analysis result of the input data; an evaluation generation unit that generates evaluation data obtained by evaluating the master data on the basis of evaluation metrics set in accordance with a speaker included in the multiple speakers; a summary generation unit that generates summary data representing at least one of the master data or the evaluation data in a format indicated by format information on the basis of preset format information; and a filter unit that extracts, from the summary data, disclosure information data corresponding to information in a disclosable range designated by level information on the basis of the level information set in accordance with a viewer of the output data, and outputs the output data based on the extracted disclosure information data.

According to another aspect of the present disclosure, there is provided an information processing method including: by an information processing device, analyzing input data regarding a dialogue between multiple speakers; generating master data serving as a source for generating output data regarding the dialogue on the basis of an analysis result of the input data; generating evaluation data obtained by evaluating the master data on the basis of evaluation metrics set in accordance with a speaker included in the multiple speakers; generating summary data representing at least one of the master data or the evaluation data in a format indicated by format information on the basis of preset format information; and extracting, from the summary data, disclosure information data corresponding to information in a disclosable range designated by level information on the basis of the level information set in accordance with a viewer of the output data, and outputting the output data based on the extracted disclosure information data.

According to still another aspect of the present disclosure, there is provided a program that causes a computer to function as: an analysis unit that analyzes input data regarding a dialogue between multiple speakers; a master generation unit that generates master data serving as a source for generating output data regarding the dialogue on the basis of an analysis result of the input data; an evaluation generation unit that generates evaluation data obtained by evaluating the master data on the basis of evaluation metrics set in accordance with a speaker included in the multiple speakers; a summary generation unit that generates summary data representing at least one of the master data or the evaluation data in a format indicated by format information on the basis of preset format information; and a filter unit that extracts, from the summary data, disclosure information data corresponding to information in a disclosable range designated by level information on the basis of the level information set in accordance with a viewer of the output data, and outputs the output data based on the extracted disclosure information data.

In the information processing device, the information processing method, and the program according to the aspects of the present disclosure, input data regarding a dialogue between multiple speakers is analyzed, master data serving as a source for generating output data regarding the dialogue is generated on the basis of an analysis result of the input data, evaluation data obtained by evaluating the master data is generated on the basis of evaluation metrics set in accordance with a speaker included in the multiple speakers, summary data representing at least one of the master data or the evaluation data in a format indicated by format information is generated on the basis of preset format information, and disclosure information data corresponding to information in a disclosable range designated by level information is extracted from the summary data on the basis of the level information set in accordance with a viewer of the output data, and the output data based on the extracted disclosure information data is output.

Note that the information processing device according to the aspect of the present disclosure may be an independent device or an internal block constituting one device.

### BRIEF DESCRIPTION OF DRAWINGS

FIG. 1 is a block diagram illustrating a configuration example of an embodiment of an information processing device to which the present disclosure is applied.

FIG. 2 is a block diagram illustrating a detailed configuration example of the information processing device illustrated in FIG. 1.

FIG. 3 is a diagram illustrating an example of a data processing flow in an information processing device.

FIG. 4 is a diagram illustrating an example of a data processing flow in an information processing device.

FIG. 5 is a diagram illustrating a flow of processing up to summary generation in a case where an information processing device is used in an educational domain.

FIG. 6 is a diagram illustrating details of list generation processing in FIG. 5.

FIG. 7 is a diagram illustrating filter processing using level information in a case where an information processing device is used in an educational domain.

FIG. 8 is a diagram illustrating an example of level information in a case where an information processing device is used in an educational domain.

FIG. 9 is a diagram illustrating an effect of generating master data for each scene and generating evaluation data and summary data.

FIG. 10 is a diagram illustrating a flow of processing up to summary generation in a case where an information processing device is used in a business domain.

FIG. 11 is a diagram illustrating details of list generation processing in FIG. 10.

FIG. 12 is a diagram illustrating filter processing using level information in a case where an information processing device is used in a business domain.

FIG. 13 is a diagram illustrating a first example of output data corresponding to a confidentiality level.

FIG. 14 is a diagram illustrating a second example of output data corresponding to a confidentiality level.

FIG. 15 is a diagram illustrating a third example of output data corresponding to a confidentiality level.

FIG. 16 is a diagram illustrating an example of level information in a case where an information processing device is used in a business domain.

FIG. 17 is a diagram illustrating a processing example of a level filter unit in a case where training data is used.

FIG. 18 is a diagram illustrating an example of level information stored in a level information DB.

FIG. 19 is a flowchart illustrating a flow of processing executed by an information processing device.

FIG. 20 is a diagram illustrating another example of a data processing flow in an information processing device.

FIG. 21 is a block diagram illustrating a configuration example of hardware of a computer.

### MODE FOR CARRYING OUT THE INVENTION

### System Configuration

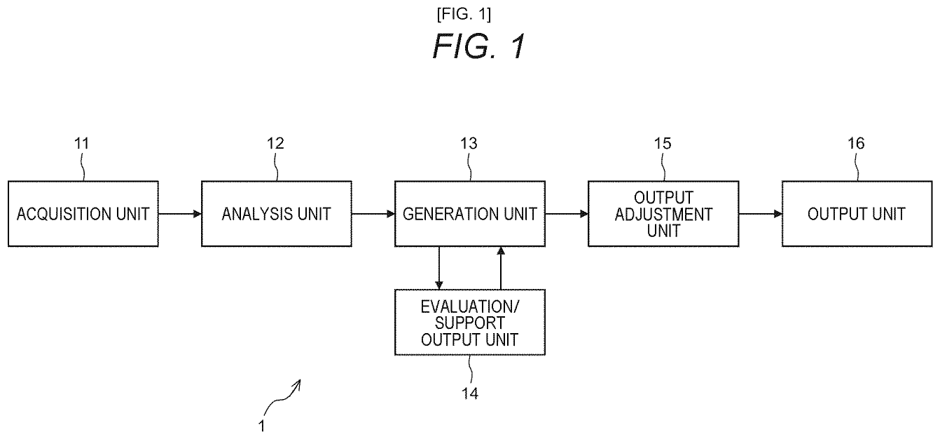

FIG. 1 is a block diagram illustrating a configuration example of an embodiment of an information processing device to which the present disclosure is applied.

An information processing device 1 is, for example, an electronic device including a dedicated device, a personal computer (PC), a server, and a display device. In FIG. 1, the information processing device 1 includes an acquisition unit 11, an analysis unit 12, a generation unit 13, an evaluation/support output unit 14, an output adjustment unit 15, and an output unit 16.

The acquisition unit 11 acquires input data obtained at the time of a dialogue between multiple speakers, and supplies the input data to the analysis unit 12. The input data is data obtained by converting audio data captured by a microphone into text data. The input data is not limited to text data, and may be data such as audio data before conversion, image data captured by a camera, and sensor data detected by a sensor. Note that a device that generates input data obtained by the microphone, the camera, or the sensor may be an external device, or may be included in the acquisition unit 11.

The analysis unit 12 analyzes the input data supplied from the acquisition unit 11, and supplies an analysis result to the generation unit 13. The analysis unit 12 performs processing such as scene detection for detecting each scene of the dialogue, speaker's utterance and determination, utterance attitude analysis for analyzing the communication modality, speaker recognition for recognizing the speaker, role detection for detecting a role (position or role) in the dialogue of the speaker, keyword extraction for extracting a keyword included in the utterance of the speaker, and the like on the input data such as the text data.

The generation unit 13 generates master data on the basis of the analysis result supplied from the analysis unit 12, and supplies the master data to the evaluation/support output unit 14. The master data is data to be a source for generating output data regarding a dialogue between multiple speakers. The evaluation/support output unit 14 generates evaluation data from the master data supplied from the generation unit 13 on the basis of evaluation metrics set according to each speaker included in multiple speakers, and supplies the evaluation data to the generation unit 13. The evaluation metrics are generated from data regarding a guideline, an agendas, and the like prepared in advance for each field such as the educational domain and the business domain. The evaluation data is data obtained by evaluating the master data.

The generation unit 13 generates summary data from the generated master data and the evaluation data supplied from the evaluation/support output unit 14 on the basis of preset format information, and supplies the summary data to the output adjustment unit 15. The summary data is data representing at least one of the master data or the evaluation data in a format indicated by the format information.

The output adjustment unit 15 adjusts the information amount of the summary data supplied from the generation unit 13 on the basis of the level information set according to the viewer of the output data, and supplies the result to the output unit 16 as output data. The adjustment of the information amount includes adjustment of the amount of information included in the summary data and change in granularity and type of information. That is, the output adjustment unit 15 extracts, from the summary data, the disclosure information data corresponding to the information in the disclosable range specified by the level information, and generates output data based on the extracted disclosure information data. The level information is prepared in advance for each field such as the educational domain and the business domain, and for example, information that can be disclosed is determined for each level according to the attribute.

The output unit 16 outputs the output data supplied from the output adjustment unit 15. The output data is data in which dialogues between multiple speakers are summarized, and includes information such as a text and an image. The output unit 16 includes a display, and can display information included in the output data. Alternatively, the output unit 16 may include a communication I/F, transmit the output data to another device via a network, and the device may present information included in the output data.

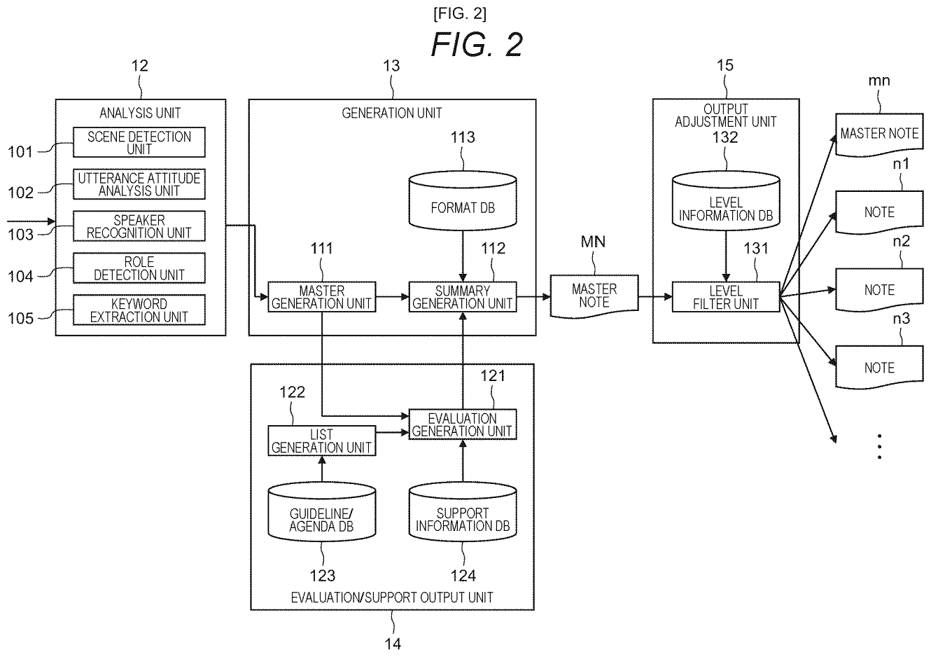

FIG. 2 is a block diagram illustrating a detailed configuration example of the information processing device 1 illustrated in FIG. 1. In FIG. 2, the analysis unit 12 includes a scene detection unit 101, an utterance attitude analysis unit 102, a speaker recognition unit 103, a role detection unit 104, and a keyword extraction unit 105. Input data such as text data obtained by converting audio data is input to the analysis unit 12.

The scene detection unit 101 analyzes the input data and detects a scene for example, opening greeting, and the like) in which a dialogue in a class or a meeting is taking place. In the scene detection, a known technology capable of detecting a specific scene by analyzing the input data such as text data can be used at least in part. The utterance attitude analysis unit 102 analyzes the input data to analyze the speaker's utterance and determination in the class or the meeting and communication modality (for example, the content of which is being spoken and the speaker's determination and attitude toward the listener).

The speaker recognition unit 103 and the role detection unit 104 analyze the input data, recognize a speaker (for example, a teacher, a student, an employee, or the like) in a class, a meeting, or the like, and detect a role (for example, a facilitator, a minute-taker, or the like) of the recognized speaker. The keyword extraction unit 105 analyzes the input data and extracts a specific keyword (for example, a keyword included in the guideline) included in the utterance of the speaker (for example, a teacher or the like).

Note that a known technology can also be used for performing processing of utterance attitude analysis, speaker recognition, role detection, and keyword extraction. The input data is not limited to text data, and may be data such as audio data and image data. Processing such as scene detection and utterance attitude analysis may be performed using audio analysis processing on the audio data, image analysis processing on the image data, and the like.

The generation unit 13 includes a master generation unit 111, a summary generation unit 112, and a format DB 113. The master generation unit 111 generates master data on the basis of the analysis result supplied from the analysis unit 12, and supplies the master data to the summary generation unit 112 and the evaluation/support output unit 14.

The master data from the master generation unit 111 and the evaluation data from the evaluation/support output unit 14 are supplied to the summary generation unit 112. The summary generation unit 112 generates summary data using the master data and the evaluation data on the basis of the format information read from the format DB 113, and supplies the summary data to the output adjustment unit 15. For example, the format information defines a format (for example, a format of an item such as an overall summary, participation, or next session) for generating summary data in a format such as a note (hereinafter referred to as a note format). Here, the summary data is output as a master note MN in a note format. Note that the summary generation unit 112 may generate the summary data using only the master data or may generate the summary data using only the evaluation data, according to the format information.

The evaluation/support output unit 14 includes an evaluation generation unit 121, a list generation unit 122, a guideline/agenda DB 123, and a support information DB 124. The evaluation generation unit 121 evaluates the master data supplied from (the master generation unit 111 of) the generation unit 13 on the basis of the evaluation list supplied from the list generation unit 122 to generate evaluation data, and supplies the evaluation data to (the summary generation unit 112 of) the generation unit 13.

The list generation unit 122 generates an evaluation list on the basis of information regarding a guideline or agenda read from the guideline/agenda DB 123, and supplies the evaluation list to the evaluation generation unit 121. It can also be said that the guideline or the agenda is evaluation metric source information serving as a source of a metric when the dialogue is evaluated. The evaluation list is an indicator (evaluation metrics) for evaluating the master data, and for example, a communication item list for evaluating whether or not an item to be communicated in the dialogue is communicated can be generated. The evaluation list is generated according to the speaker. The evaluation generation unit 121 uses an evaluation list such as a communication item list to evaluate whether or not it can be confirmed from the information included in the master data that the item to be evaluated (hereinafter, also referred to as an evaluation item) is performed. Furthermore, in a case where an item to be supported is detected on the basis of the evaluation data, the evaluation generation unit 121 can include the support information read from the support information DB 124 in the evaluation data. For example, in the case of the educational domain, the support information includes information regarding remedial teaching and instruction.

The output adjustment unit 15 includes a level filter unit 131 and a level information DB 132. On the basis of the level information read from the level information DB 132, the level filter unit 131 extracts, from the summary data supplied from (the summary generation unit 112 of) the generation unit 13, disclosure information data corresponding to information in a range that can be disclosed for the viewer's attribute of the output data, and generates and outputs the output data based on the extracted disclosure information data. For example, the level information defines information that can be disclosed in association with an attribute according to a level such as a confidentiality level (level of a confidentiality degree) for each field such as an educational domain or a business domain, and the level filter unit 131 performs filter processing using the level information to output the output data including the information that can be disclosed according to the level of the attribute given to the viewer.

For example, a master note mn is output as the output data to the viewer with the attribute having the largest amount of disclosable information at a level A. As the same note as the master note MN that is the summary data, the master note mn may have the same information amount. Therefore, the level filter unit 131 may directly output the input master note MN as the master note mn.

Furthermore, to the viewer with the attribute having the second largest amount of disclosable information at a level B, a note n1, in which the information amount is adjusted so as to be smaller than that of the master note mn, is output as the output data. To the viewer with the attribute having the third largest amount of disclosable information at a level C, a note n2, in which the information amount is adjusted so as to much smaller than that of the note n1, is output, and to the viewer with the attribute having the fourth largest amount of disclosable information at a level D, a note n3, in which the information amount is adjusted so as to be much smaller than that of the note n2, is output. Although not illustrated due to repetition, to the viewer with the attribute having the smallest amount of disclosable information, a note, in which the information amount is adjusted so as to be the smallest, is output.

Note that, in the level filter unit 131, as a method for recognizing which attribute of a viewer who views the output data belongs to, for example, the following method can be used. That is, since a table in which the viewer's ID and attribute are associated with each other is held in advance, and the viewer inputs the ID using the information processing device 1 or another device, the viewer's attribute can be specified on the basis of the input ID. Alternatively, when the viewer views the output data, the viewer's attribute may be automatically recognized or the viewer's attribute may be instructed by an operation of an administrator who manages the output data. That is, as long as it is only required to recognize which attribute the viewer has, any method can be used.

### Data Processing Flow

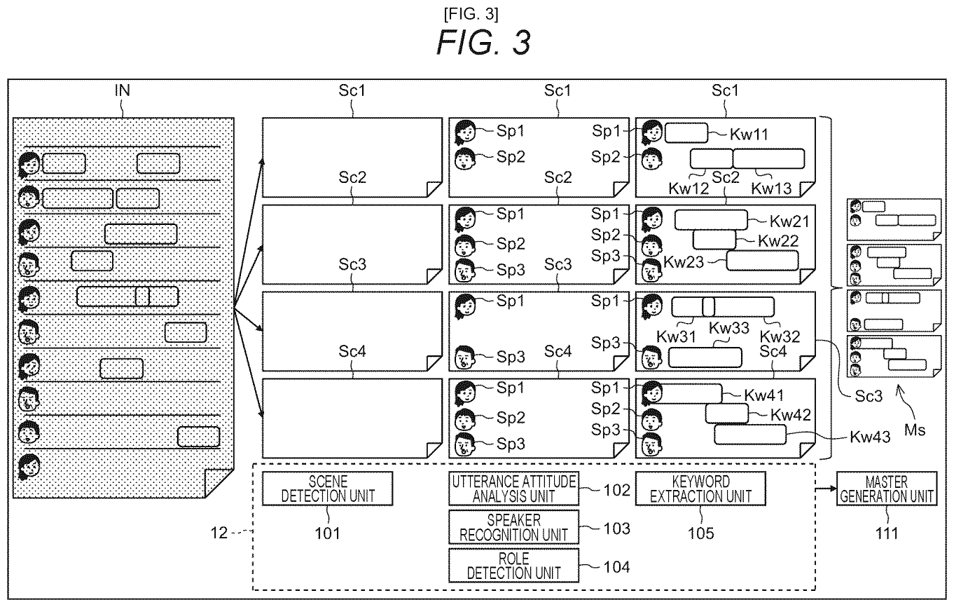

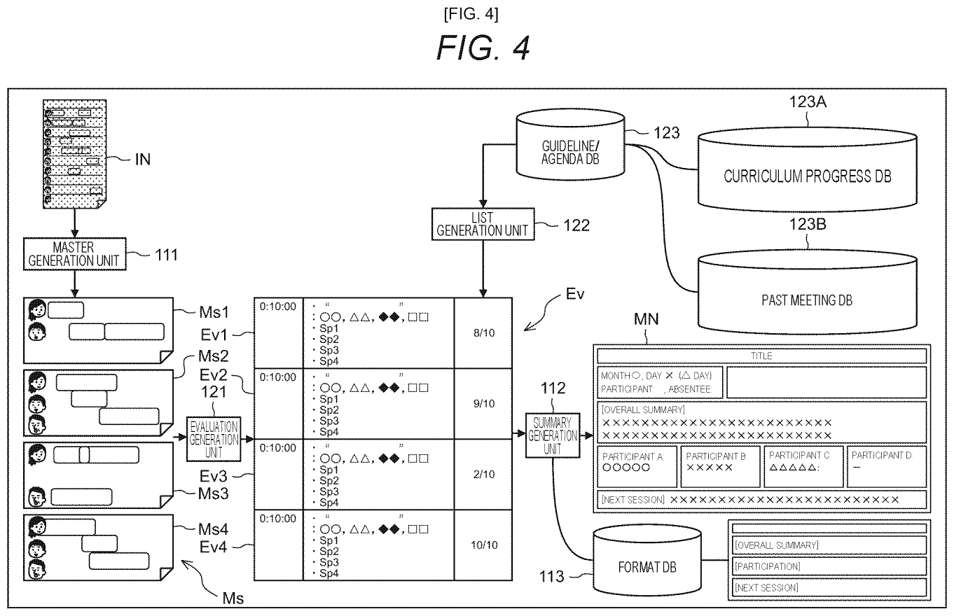

Next, an example of a data processing flow in the information processing device 1 will be described with reference to FIGS. 3 and 4. FIG. 3 illustrates data processed by the analysis unit 12 and the master generation unit 111 of the generation unit 13. FIG. 4 illustrates data processed by the master generation unit 111 and summary generation unit 112 of the generation unit 13, and the evaluation generation unit 121 and list generation unit 122 of the evaluation/support output unit 14.

In FIG. 3, the scene detection unit 101 detects a scene Sc1, a scene Sc2, a scene Sc3, a scene Sc4, . . . by processing input data IN and specifying, for example, a time point at which the theme of the dialogue has changed. when the utterance attitude analysis unit 102, the speaker recognition unit 103, and the role detection unit 104 processes the input data IN, speakers such as a speaker Sp1, a speaker Sp2, and a speaker Sp3 are recognized for each scene, and the utterance attitude and the role are obtained for each speaker. When the keyword extraction unit 105 processes the input data IN, a specific keyword Kw included in the utterance of each of the speakers such as the speaker Sp1, the speaker Sp2, and the speaker Sp3 for each scene.

That is, the analysis unit 12 performs the analysis processing on the input data IN such as text data, and thus it is possible to obtain analysis results indicating who is speaking, in what role or attitude, and what is being said for each scene. For example, in the scene Sc1, the speaker Sp1 and the speaker Sp2 are present, and it is analyzed that the speaker Sp1 made an utterance including a keyword Kw11 and the speaker Sp2 made an utterance including keywords Kw12 and Kw13. In the scene Sc2, the speaker Sp1, the speaker Sp2, and the speaker Sp3 are present, and it is analyzed that the speaker Sp1 made an utterance including a keyword Kw21, the speaker Sp2 made an utterance including a keyword Kw22, and the speaker Sp3 made an utterance including a keyword Kw23.

Furthermore, in the scene Sc3, the speaker Sp1 and the speaker Sp3 are present, and it is analyzed that the speaker Sp1 made an utterance including keywords Kw31 and Kw32 and the speaker Sp3 made an utterance including a keyword Kw33. In the scene Sc4, the speaker Sp1, the speaker Sp2, and the speaker Sp3 are present, and it is analyzed that the speaker Sp1 made an utterance including a keyword Kw41, the speaker Sp2 made an utterance including a keyword Kw42, and the speaker Sp3 made an utterance including a keyword Kw43.

Master data Ms including these analysis results is generated by the master generation unit 111. In FIG. 4, the master data Ms includes, for each scene, master data Ms1 corresponding to the scene Sc1, master data Ms2 corresponding to the scene Sc2, master data Ms3 corresponding to the scene Sc3, and master data Ms4 corresponding to the scene Sc4. In FIG. 4, the evaluation generation unit 121 evaluates the master data Ms on the basis of the evaluation list generated by the list generation unit 122 and generates evaluation data Ev. The evaluation list includes, for example, a communication item list that is a list of communication items to be conveyed in a dialogue, a question item list that is a list of question items to be asked, and a confirmation item list which is a list of confirmation items to be checked. Furthermore, the evaluation list may include multiple types of evaluation items as well as a single type of evaluation item such as a communication item, a question item, and a confirmation item. That is, the evaluation list is a list including at least any of evaluation items such as the communication item, the question item, and the confirmation item.

The guideline/agenda DB 123 includes, for example, a curriculum progress DB 123A and a past meeting DB 123B. The database stored in the guideline/agenda DB 123 can be set according to participants (speakers engaging in a dialogue). The curriculum progress DB 123A stores information regarding progress based on the training curriculum used in the educational domain. The past meeting DB 123B stores information regarding past meetings used in the business domain. For example, in a case where the information processing device 1 is used in the educational domain, the list generation unit 122 reads information regarding the progress based on the training curriculum from the curriculum progress DB 123A and generates an evaluation list. Furthermore, in a case where the information processing device 1 is used in a business domain, the list generation unit 122 generates an evaluation list on the basis of information regarding past meetings read from the past meeting DB 123B.

The evaluation data Ev includes, for each scene, evaluation data Ev1 for the master data Ms1, evaluation data Ev2 for the master data Ms2, evaluation data Ev3 for the master data Ms3, and evaluation data Ev4 for the master data Ms4. The evaluation data Ev1 is an evaluation data related to the scene Sc1, 0:10:00 represents a time, “ ” describes content related to a curriculum, Sp1 to Sp4 represent speakers, and symbols such as ∘∘ and the like represent keywords or the like included in the utterance of each speaker. 8/10 indicates that the evaluation of the scene Sc1 is eight out of 10 points through the evaluation using the evaluation list. Similarly, in the evaluation data Ev2 to Ev4, the scene Sc2 is evaluated as nine points, the scene Sc3 is evaluated as two points, and the scene Sc4 is evaluated as 10 points through the evaluation using the evaluation list.

The summary generation unit 112 generates a master note MN as summary data from the master data Ms and the evaluation data Ev on the basis of the format information read from the format DB 113. Here, since the format information includes information regarding a note format including items such as the overall summary, participation, and a next session, the master note MN is generated in the note format in which the master data Ms and the evaluation data Ev are organized according to the format information. In the master note MN, a title and a date, information regarding a participant or an absentee, an overall summary, information regarding participants A to D, and information for the next session are organized in the note format.

For example, in the overall summary of “××××××××××. . . ”, the overall summary can be generated using the evaluation data of each scene, such as the summary based on the evaluation data Ev1 of the scene Sc1 in the preceding stage, the summary based on the evaluation data Ev2 and Ev2 of the scenes Sc2 and Sc3 in the middle stage, and the summary based on the evaluation data Ev4 of the scene Sc4 in the subsequent stage. Furthermore, information regarding a participant A of “∘∘∘∘∘” is information regarding a participant A based on the evaluation data Ev1 and Ev3 of the scene Sc1 and Sc3, information regarding a participant B of “×××××” is information regarding a participant B based on the evaluation data Ev1 of the scene Sc1, and information regarding a participant C of “ΔΔΔΔΔ” is information regarding a participant C based on the evaluation data Ev2, Ev3, and Ev4 of the scenes Sc2, Sc3, and Sc4. Pieces of information regarding these participants A, B, and C can be generated using the evaluation data of each scene. At least a part of the information for the next session of “××××××. . . ” can be generated using the evaluation data of each scene, such as using the information based on the evaluation data Ev4 of the scene Sc4.

Note that the format of the summary data is not limited to the note format such as the master note MN, and other formats may be used. However, it is desirable to be a format in which the viewer can easily confirm the content of the dialogue. The master note MN as the summary data is adjusted to an information amount according to the viewer's attribute based on the level information and output as the output data, and the detailed contents thereof will be described in a usage example in a case of use in a specific field such as an educational domain or a business domain to be described later.

### Usage Example in Educational Domain

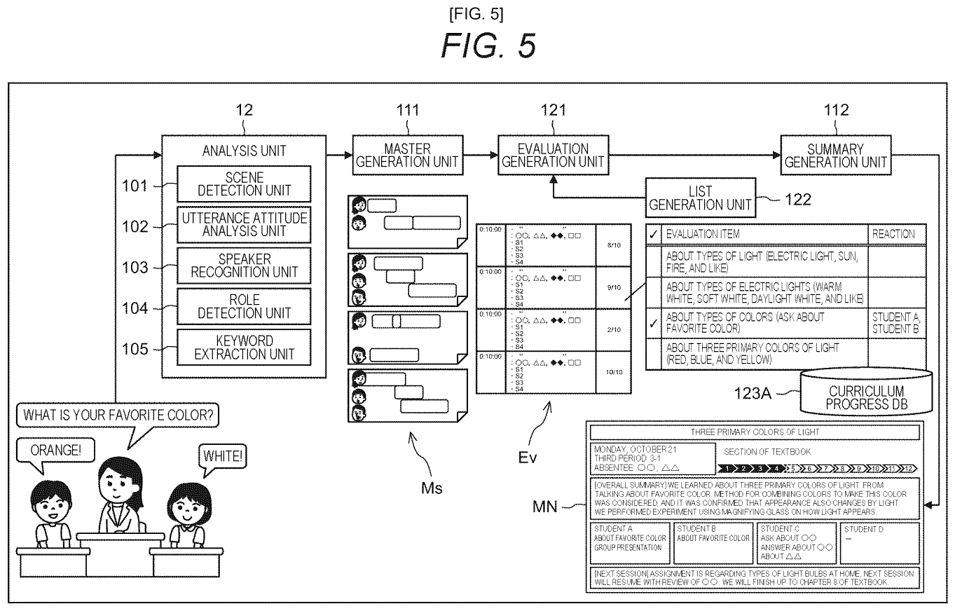

The information processing device 1 can be used in various fields. For example, a case where the information processing device 1 is used in an educational domain will be described. FIG. 5 is a diagram illustrating a flow of processing up to generation of the summary data in a case where the information processing device 1 is used in the educational domain.

In FIG. 5, input data obtained at the time of conversation between a teacher and a student in class is analyzed by the analysis unit 12. The analysis unit 12 performs analysis processing, such as scene detection, utterance attitude analysis, speaker recognition, role detection, and keyword extraction, on the input data. For example, in the scene detection, a scene such as a class start command, an explanation using a textbook, or a question and answer is detected. In the utterance attitude analysis, the determination included in the utterance by the speakers such as a teacher and a student, and the utterance attitude such as a communication modality are analyzed. In the speaker recognition and the role detection, the speaker such as the teacher or the student is recognized and the role is detected. In the keyword extraction, a specific keyword (for example, “favorite color” or the like) is extracted from the utterance of the speaker such as the teacher or the student.

In this manner, it is possible to obtain an analysis result indicating the roles, attitudes, and utterances made by the teacher and the student for each scene in class such as a class start command or an explanation using a textbook. The master generation unit 111 generates the master data Ms on the basis of the analysis result of the input data. For example, the master data Ms includes information indicating roles, attitudes, and utterances made by the teacher and the student for each scene in class.

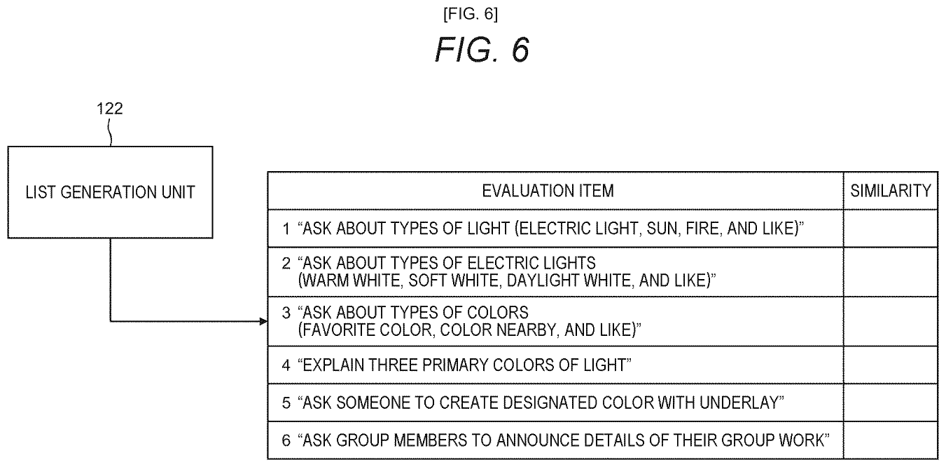

The evaluation list used when the evaluation generation unit 121 performs evaluation is generated by the list generation unit 122. FIG. 6 is a diagram illustrating details of list generation processing of the list generation unit 122 in FIG. 5. In FIG. 6, the list generation unit 122 generates an evaluation list by converting information (items in the bulleted list) regarding the progress based on the training curriculum stored in the curriculum progress DB 123A into a format of the evaluation item. Here, by performing natural language processing on the text data of the training curriculum and detecting a relationship (adversative conjunction or the like) between sentences, evaluation items can be generated from sentences before and after the sentences.

For example, in a case where the target class is a science, a list including six evaluation items (communication items, question items, confirmation items, and the like) such as “Ask about the types of light (electric light, sun, fire, and the like)”, “Ask about the types of electric lights (warm white, soft white, daylight white, and the like)”, “Ask about the types of colors (favorite color, color nearby, and the like)”, “Explain the three primary colors of light”, “Ask someone to create the designated color with an underlay”, and “Ask group members to announce the details of their group work” is generated on the basis of the information regarding the progress based on the curriculum of the class regarding the “three primary colors of light”.

The evaluation generation unit 121 evaluates the master data Ms using the evaluation list generated by the list generation unit 122, and generates the evaluation data Ev according to the evaluation result. For example, since the master data Ms includes information indicating roles, attitudes, and utterances made by the teacher and the student for each scene in class, the implementation state of the evaluation items included in the evaluation list, an achievement state when the evaluation items have been implemented, and the like are evaluated for each scene in class on the basis of these pieces of the information.

More specifically, the master data Ms includes the utterances (important utterances including keywords) of the teacher and the student in a certain scene in class, and in a case where the similarity between these utterances (important utterances including keywords) and wording included in the evaluation item is obtained and the similarity exceeds a threshold, it can be evaluated that the evaluation item has been performed. That is, the wording of the evaluation item included in the evaluation list does not need to completely match the utterance of the teacher or the like, and in a case where the utterance is close to a certain extent, it can be evaluated that the item to be evaluated is implemented. However, in a case where the wording completely matches the utterance or in a case where the similarity is higher, the evaluation may be made higher (a higher score may be given). For example, in a case where a teacher asks a question “what is your favorite color?” and a student answers “orange” or “white” in a scene of an explanation using a textbook, when information regarding the conversation is included in the master data Ms, the evaluation generation unit 121 determines that the information corresponds to the third evaluation item in the evaluation list, and performs scoring that gives a high score to the scene where the conversation has been performed.

The summary generation unit 112 generates summary data from the master data Ms and the evaluation data Ev on the basis of the format information. For example, in a case where the format information includes information regarding a note format including items such as an overall summary, class participation of each student (hereinafter, also referred to as class participation), and a plan for the next class (hereinafter, also referred to as next session), a master note MN in a note format in which the master data Ms and the evaluation data Ev are organized according to the format information is generated as the summary data.

In FIG. 5, the master note MN is an example of the summary data generated by the summary generation unit 112. The master note MN includes a title of “three primary colors of light”, a date of “Monday, October 21”, information regarding absentees of “∘∘, ΔΔ”, and information regarding a progress state indicating that four out of 12 chapters of the textbook are completed. Furthermore, the master note MN includes information organized for each item of the overall summary, the class participation, and the next session according to the format information.

Specifically, information regarding the overall summary of “We learned about the three principles of light. From talking about the favorite color, a method for combining colors to make the color was considered, and it was confirmed that the appearance also changes by light. We performed an experiment using the magnifying glass on the type of colors and how light appears.” is included in the field of the item of the overall summary. Information regarding the utterance of a student A in “Group presentation concerning the favorite colors”, information regarding the utterance of a student B in “Regarding the favorite colors”, and information regarding the utterance of a student C in “Question about ∘∘, Answer about ∘∘, and Regarding ΔΔ” are included in the fields of the item of the class participation. Information regarding the next session or the assignment in “The assignment is regarding the types of light bulbs at home, the next session will resume with the review of ∘∘. We will finish up to Chapter 8 of the textbook.” is included in the field of the next session. These pieces of information are appropriately extracted from the information for each scene of the evaluation data Ev in accordance with the format.

The master note MN can be used by introducing the information processing device 1, and it is possible to organize long conversations (dialogues) by multiple speakers including a teacher and a student in a format of a note. Therefore, it is possible to objectively look back on the class at a lower cost. Furthermore, by adopting a format including information (for example, a scoring result or the like) regarding the evaluation data Ev in the master note MN, a teacher can learn his/her past class or a class of a teacher who is a colleague using the master note MN, and can use this as a trigger for improving future classes. Moreover, the teacher who looks at the master note MN can look back on students' interests, level of understanding, the attitudes in class, and the like on the basis of students' reactions and the number of utterances.

As described above, the master note MN alone is useful, but it is also assumed that the information obtained from the dialogue is not information of an appropriate level for the viewer of the information. Therefore, the information processing device 1 performs filtering processing using the level information to appropriately output the information obtained from the dialogue to each viewer of the information. Furthermore, when an attempt is made to disclose information to related parties, such as student's guardian, who are subjects for information disclosure but not subjects for all information disclosure, there is a restriction on an accessible information level. Therefore, it is assumed that the information disclosure also incurs the cost. By using the information processing device 1 capable of automatically managing such information disclosure and appropriately outputting the information, the cost of information disclosure can be reduced.

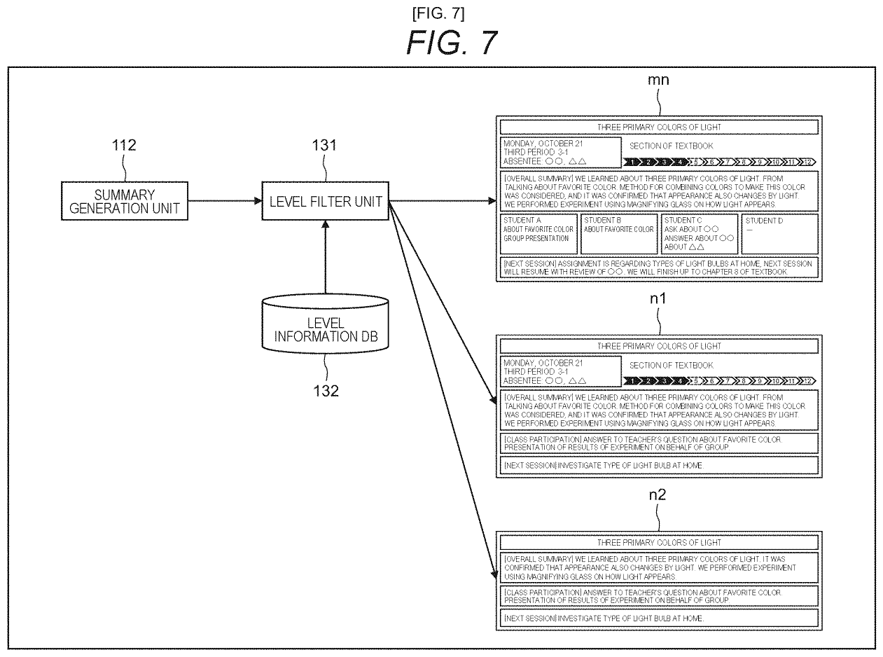

FIG. 7 is a diagram illustrating the filter processing using the level information in a case where the information processing device 1 is used in the educational domain. In FIG. 7, on the basis of the level information stored in the level information DB 132, the level filter unit 131 extracts the disclosure information data corresponding to the information in the disclosable range designated by the level information from the master note MN as the summary data, and generates output data based on the extracted disclosure information data. For example, as the output data, a master note mn having the same information amount as that of the master note MN, a note n1 whose information amount is adjusted due to factors such as having less information than the master note mn, or a note n2 whose information amount is adjusted due to factors such as having even less information than the note n1 is generated according to the level information.

In FIG. 7, similarly to the master note MN of FIG. 5, the master note mn includes a date, an absentee, a progress state, an overall summary, class participation, and information regarding the next session. That is, in a case where the viewer (for example, the teacher) has an attribute that allows all the information in the level information to be disclosed, the level filter unit 131 outputs, as the output data which is the master note mn, the master note MN which is the summary data, in the original format.

The note n1 includes a title of “three primary colors of light”, a date of “Monday, October 21”, information regarding absentees of “∘∘, ΔΔ”, and information regarding a progress state indicating that four out of 12 chapters of the textbook are completed. Furthermore, the note n1 includes information organized for each item of the overall summary, the class participation, and the next session according to the format information, but the information amount is adjusted due to a factor such as having less information than the master note mn. Specifically, the content of the overall summary is the same, but the class participation includes not information regarding the individual student but information that does not specify the individual, that is, information regarding “Answer to the teacher's question about favorite color. Presentation of the results of the experiment on behalf of the group”. Furthermore, the content of the next session is also simplified as in “investigate the type of light bulb at home” (granularity of information is changed).

The note n2 includes a title of “three primary colors of light”, but does not include information regarding the date, the absentee, and the progress state. Furthermore, the note n2 includes information organized for each item of the overall summary, the class participation, and the next session according to the format information, but the information amount is adjusted due to a factor such as having less information than the note n1. Specifically, the class participation and the content of the next session are the same, but the content of the overall summary is simplified as in “We learned about the three principles of light. It was confirmed that the appearance also changes by light. We performed an experiment using the magnifying glass”.

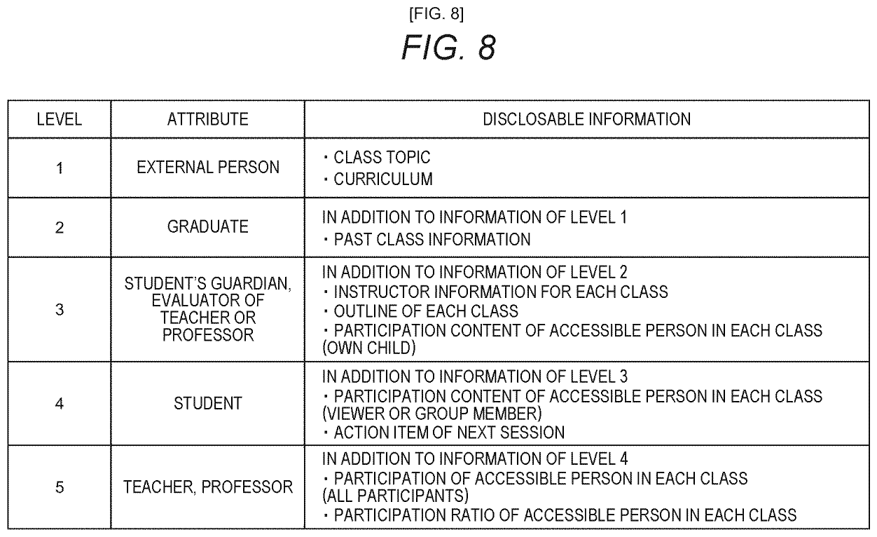

In a case where the information processing device 1 is used in the educational domain, the level information stored in the level information DB 132 is, for example, information as illustrated in FIG. 8. In FIG. 8, a table indicating the level information associates the attribute with the disclosable information for each of the five levels from one to five. In FIG. 8, as the numerical value indicating the level decreases, the amount of information that can be disclosed decreases. On the other hand, as the numerical value indicating the level increases, the amount of information that can be disclosed increases.

Level 1 indicates that information regarding a class topic and a curriculum is included as information that can be disclosed to a viewer having an attribute indicating that the viewer is external (an external person). Level 2 indicates that information regarding the past class is included in addition to the disclosable information of level 1 as the information that can be disclosed to a viewer having an attribute indicating that the viewer is a graduate. Level 3 indicates that, as the information that can be disclosed to a viewer having the attribute indicating the viewer is the student's guardian or the evaluator of the teacher or the professor, instructor information for each class and information regarding the outline of each class and the participation content of the accessible person in each class (for example, the participation content of the own child) are included in addition to the disclosable information of Level 2.

Level 4 indicates that, as the information that can be disclosed to a viewer having the attribute indicating the viewer is a student, information regarding the participation content of the accessible person in each class (for example, the participation content of the viewer or the group member) and the action item of the next session is included in addition to the disclosable information of Level 3. Level 5 indicates that, as the information that can be disclosed to a viewer having the attribute indicating that the viewer is a teacher or a professor, the information regarding the participation of the accessible person in each class (for example, all the participants) and the participation ratio of the accessible person in each class are included in addition to the disclosable information of Level 4.

By holding such level information, for example, in a case where the teacher at Level 5 or the student at Level 4 is a viewer, the master note mn is output as output data from the level filter unit 131. Furthermore, for example, in a case where the guardian at Level 3 or the graduate at Level 2 is a viewer, the note n1 is output as the output data, and in a case where the external person at Level 1 is a viewer, the note n2 is output as the output data.

In this manner, by outputting the output data corresponding to the level (confidentiality level) of the viewer's attribute using the level information, it is possible to provide information in a disclosable range for each viewer of the output data. As a result, it is possible to provide necessary information such as the master note mn, the note n1, and the like to the viewer, and this encourages the viewer to look back on participation in class. Therefore, it is possible to encourage deeper engagement beyond just listening and promote active learning. Furthermore, it is possible to provide information such as class content to a third party such as a guardian at a lower cost. In the master note mn, the note n1, and the note n2 illustrated in FIG. 7, information regarding the entire class such as the overall summary is included, but a note for a specific participant may be generated. For example, in a case where the guardian of the student A is the viewer, a note in which information regarding the student A is organized can be generated. Furthermore, by using the output data of the master note mn, the note n1, and the like, it is possible to store data that has been difficult to evaluate and record in the related art and to utilize the data after that.

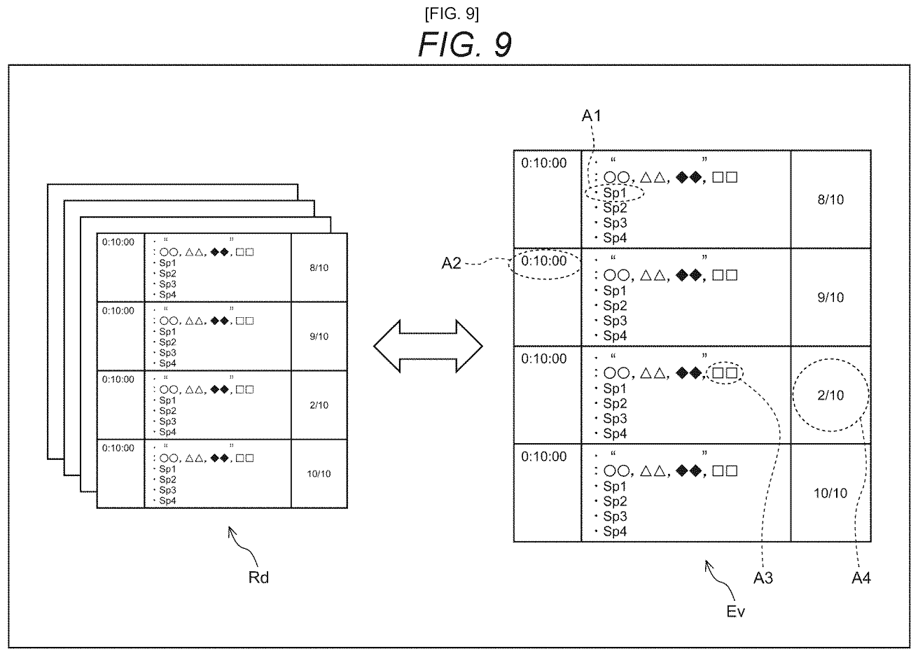

FIG. 9 is a diagram illustrating an effect of generating master data for each scene and generating evaluation data and summary data. In FIG. 9, reference data Rd is data such as past class data, sample class data, and guidelines. In the information processing device 1, by comparing the evaluation data Ev generated by the evaluation generation unit 121 with the reference data Rd, it is possible to present, to a teacher or a student, objective information regarding a portion to be supported (for example, a portion to be reinforced, a portion where information is not sufficiently covered, and the like). Thus, this encourages the teacher or the student to look back on the participation in class, and can promote active learning.

For example, in a case where the evaluation data Ev includes information regarding how much each participant contributes to the discussion for each scene, when the student who is the speaker Sp1 does not speak about “three principles of light” (A1 in the drawing), it is possible to present a supplementary learning material related to “three principles of light” to the student. Alternatively, in a case where portions (A2 to A4 in the drawing) where the adaptive learning is to be performed are detected from the evaluation data Ev, information regarding the next class including the portions can be presented to the teacher who has performed the class. The adaptive learning is learning that provides learning materials analyzing a result or a process and continues until a correct answer is obtained to overcome a weak point. Note that the information regarding the supplementary learning material and instructional reference is stored in the support information DB 124 as the support information, and can be referred to as necessary when the evaluation generation unit 121 generates the evaluation data.

As described above, by using the information processing device 1 in the educational domain, at the education site, it is difficult to look back on and evaluate dialogue that took place through interactions among multiple participants, such as utterances in class and group discussions and it is difficult to promote efficient learning and improvement. However, by outputting the output data presented in a format such as a note format, a viewer can easily look back on the class and confirm the evaluation. When the output data is automatically output after the end of the class, the teacher or the student can immediately look back on the class. Since the format of the information presented by the output data is well-organized, there is also an advantage that the viewer can easily view and evaluate the information. Furthermore, since the output data is generated from the summary data at the confidentiality level corresponding to the viewer's attribute using the level information, the output data including appropriate information can be output for each viewer. For example, when the viewer is a participant in a class such as a teacher or a student, it is possible to impose a restriction preventing the guardian of the student from browsing the information.

### Usage Example in Business Domain

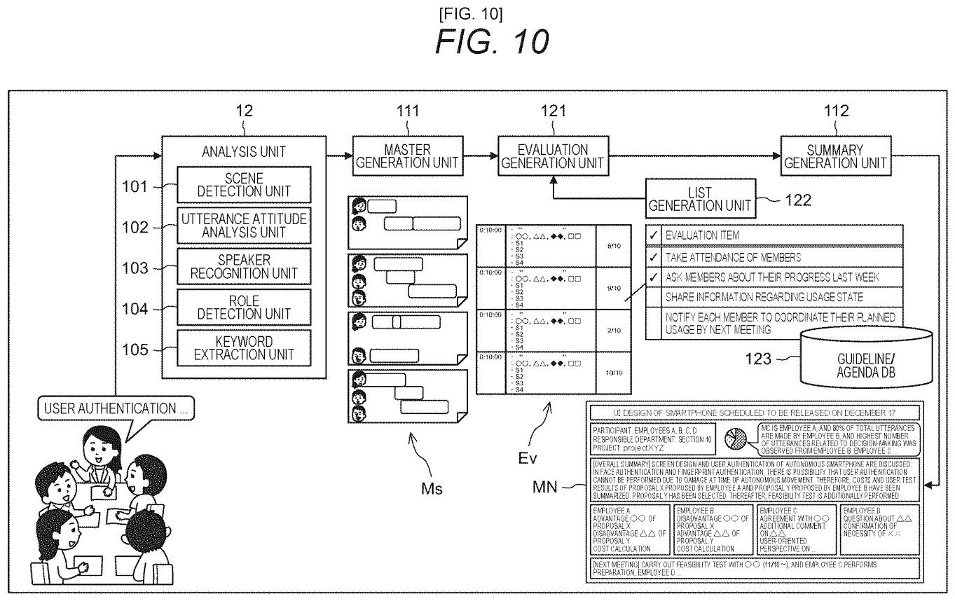

The information processing device 1 can also be used, for example, in a business domain. FIG. 10 is a diagram illustrating a flow of processing up to generation of the summary data in a case where the information processing device 1 is used in the business domain.

In FIG. 10, input data obtained at the time of conversation among multiple employees in a meeting is analyzed by the analysis unit 12. The analysis unit 12 performs analysis processing, such as scene detection, utterance attitude analysis, speaker recognition, role detection, and keyword extraction, on the input data. For example, in the scene detection, scenes such as attendance check, progress state check, explanation from each person in charge, and confirmation of the next meeting are detected. In the utterance attitude analysis, the determination included in the utterance by the speakers such as employees who give presentations or ask questions, and the utterance attitude such as a communication modality are analyzed. In the speaker recognition and the role detection, the speaker such as an employee A or an employee B is recognized and the role (a facilitator, a minute-taker, or the like) is detected. In the keyword extraction, a specific keyword (for example, “user authentication” or the like) is extracted from the utterance of the speaker such as the employee who gives a presentation or ask questions.

In this manner, it is possible to obtain an analysis result indicating a role, an attitude, and utterances made by the employee who is a participant in the meeting for each scene during the meeting, such as attendance check and progress state check. The master generation unit 111 generates the master data Ms on the basis of the analysis result of the input data. For example, the master data Ms includes information indicating the role, the attitude, and the utterances made by the employee who is a participant for each scene during the meeting.

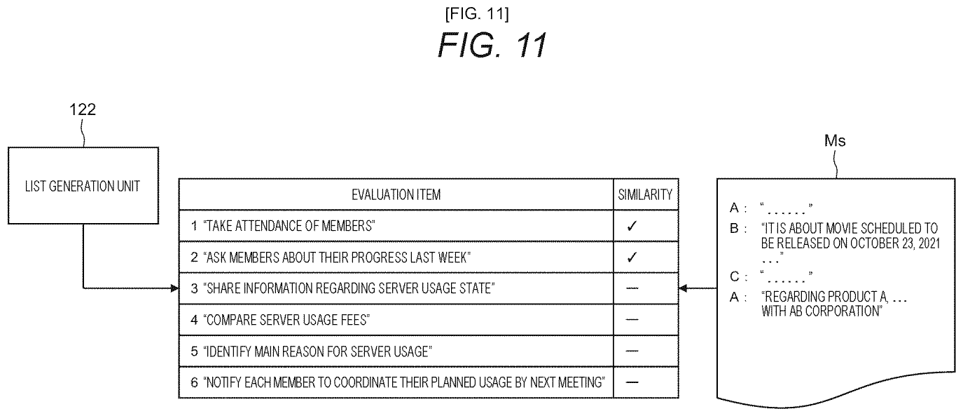

The evaluation list used when the evaluation generation unit 121 performs evaluation is generated by the list generation unit 122. FIG. 11 is a diagram illustrating details of list generation processing of the list generation unit 122 in FIG. 10. In FIG. 11, the list generation unit 122 generates an evaluation list by converting information (items in the bulleted list) regarding the agenda and past meeting, which is stored in the guideline/agenda DB 123 including the past meeting DB 123B into a format of the evaluation item. For example, a list including six evaluation items (communication items, question items, confirmation items, and the like) such as “Take attendance of the members”, “Ask the members about their progress last week”, “Share information regarding a server usage state”, “Compare server usage fees”, “Identify the main reason for server usage”, and “Notify each member to coordinate their planned usage by the next meeting” is generated from the information regarding the agenda.

The evaluation generation unit 121 evaluates the master data Ms using the evaluation list generated by the list generation unit 122, and generates the evaluation data Ev according to the evaluation result. For example, since the master data Ms includes information indicating roles, attitudes, and utterances made by the employees who are participants for each scene during the meeting, the implementation state of the evaluation items included in the evaluation list, an achievement state when the evaluation items have been implemented, and the like are evaluated for each scene during the meeting on the basis of these pieces of the information. More specifically, in FIG. 11, the master data Ms includes the utterances (important utterances including keywords) of the employee A, the employee B, and an employee C in the scene during the meeting, and in a case where the similarity between these utterances (important utterances including keywords) and wording included in the evaluation item is obtained and the similarity exceeds a threshold, it can be evaluated that the item to be evaluated has been performed.

The summary generation unit 112 generates summary data from the master data Ms and the evaluation data Ev on the basis of the format information. For example, in a case where the format information includes information regarding a note format including items such as an overall summary, meeting participation of each employee (hereinafter, also referred to as meeting participation), and a plan for the next meeting (hereinafter, also referred to as next meeting), the master note MN in a note format in which the master data Ms and the evaluation data Ev are organized according to the format information is generated as the summary data.

In FIG. 10, the master note MN is an example of the summary data generated by the summary generation unit 112. The master note MN includes a title of “UI design of a smartphone scheduled to be released on December 17”, participants of “Employee A, Employee B, Employee C, and Employee D”, a responsible department which is “Section 10”, information regarding a project name of “project XYZ”, and information indicating an evaluation (feedback) of the meeting stating that “MC is an employee A, and 80% of the total utterances are made by an employee B . . . ”. Furthermore, the master note MN includes information organized for each item of the overall summary, the meeting participation, and the next meeting according to the format information.

Specifically, information regarding the overall summary of “The screen design and user authentication of an autonomous smartphone are discussed. In the face authentication and the fingerprint authentication, there is a possibility that the user authentication cannot be performed due to damage at the time of autonomous movement. Therefore, the costs and user test results of Proposal X proposed by Employee A and Proposal Y proposed by Employee C have been summarized. Proposal Y has been selected. Thereafter, a feasibility test is additionally performed.” is included in the field of the item of the overall summary. The field of participation in the meeting includes information regarding the utterance of Employee A stating “Advantage of Proposal X: ∘∘, Disadvantage of Proposal Y: ΔΔ, and Cost calculation” and information regarding the utterance of Employee B stating “Disadvantage of Proposal X: ∘∘, Advantage of Proposal Y: ΔΔ, and cost calculation”. The field of participation in the meeting includes information regarding the utterance of Employee C stating “Agreement with ∘∘, additional comment on ΔΔ, and a user-oriented perspective on . . . ” and information regarding the utterance of Employee D stating “Question about ΔΔ and Confirmation necessity of ××”. Information regarding the next meeting that is “Carry out a feasibility test with (11/10~), Employee C performs preparation, Employee D . . . ” is included in the field of the item of the next meeting. These pieces of information are appropriately extracted from the information for each scene of the evaluation data Ev in accordance with the format.

The use of such a master note MN is possible by introducing the information processing device 1, and it is possible to reduce the time and effort required for the meeting participants to share information and reduce the cognitive cost at the time of verifying information (for example, it is possible to save time and effort for a participant to prepare meeting minutes), and it is possible to assist in looking back on the meeting. Furthermore, a person who does not participate in the meeting can also share information by referring to the master note MN. Here, even when the information is used in the business domain, it is not necessary to disclose all the information of the master note MN depending on the viewer of the information, and there is a case where the information is not at an appropriate level. Therefore, by performing filter processing using the level information, information obtained from the conversation at an appropriate level is output for each viewer of the information.

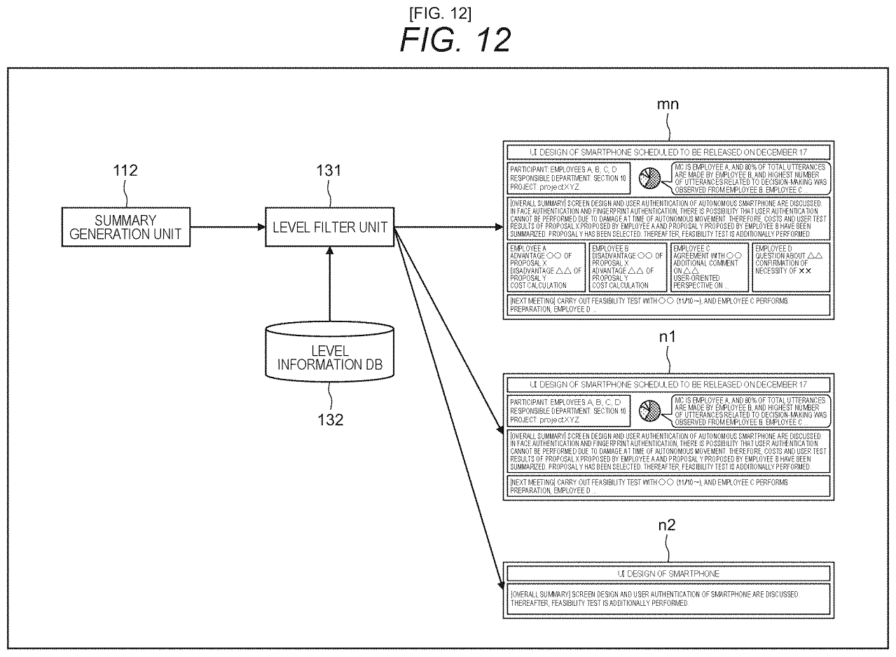

FIG. 12 is a diagram illustrating the filter processing using the level information in a case where the information processing device 1 is used in the business domain. In FIG. 12, the level filter unit 131 generates and outputs the master note mn, the note n1, or the note n2 as output data from the master note MN as summary data on the basis of the level information stored in the level information DB 132.

In FIG. 12, similarly to the master note of FIG. 10, the master note mn includes a participant, a project name, a meeting evaluation, an overall summary, meeting participation, and information regarding the next meeting. That is, in a case where the viewer (for example, the person in charge) has an attribute that allows all the information in the level information to be disclosed, the level filter unit 131 outputs, as the output data which is the master note mn, the master note MN which is the summary data, in the original format.

The note n1 includes a title of “UI design of a smartphone scheduled to be released on December 17”, participants of “Employee A, Employee B, Employee C, and Employee D”, a responsible department which is “Section 10”, and information regarding a project name of “project XYZ”. Furthermore, the note n1 includes information organized for each item of the overall summary and next meeting corresponding to the format information, but information regarding each employee participating in the meeting is excluded, and the information amount is adjusted due to a factor such as having less information than the master note mn.

The note n2 includes a title of “UI design of a smartphone”, but is simplified compared to the master note mn and the note n1, and an information amount is adjusted. The note n2 is different from the master note mn and the note n1 in that information regarding a participant, a responsible department, a project name, and meeting evaluation is excluded. Furthermore, the note n2 does not include information regarding participation in the meeting and the next meeting, but includes information organized for the item that is an overall summary. However, the information is simplified to state that “A discussion has been made on the screen design of the smartphone and the user authentication. Thereafter, a feasibility test is additionally performed.”, and the information amount is adjusted.

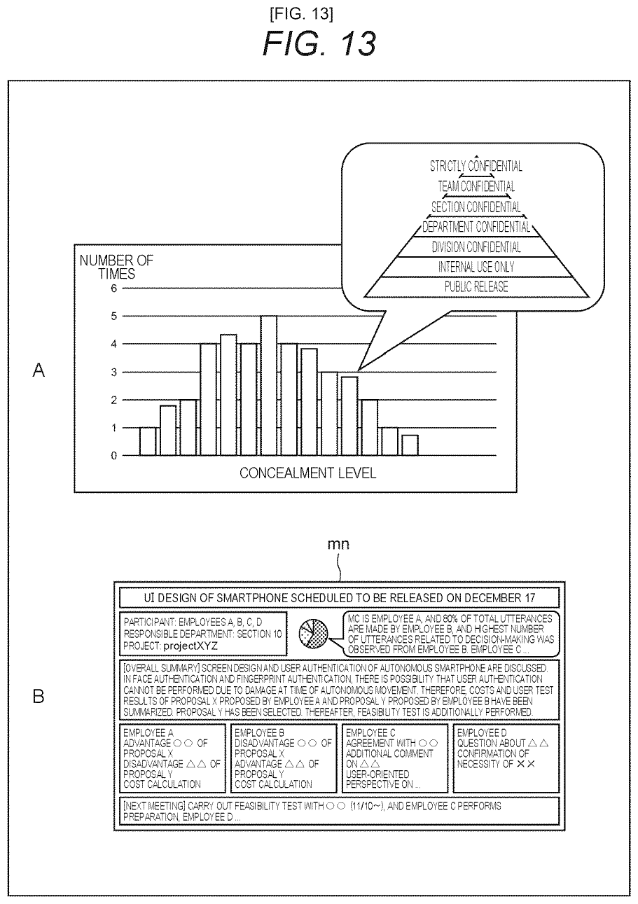

Here, output data corresponding to the confidentiality level will be described with reference to FIGS. 13 to 15. For example, in a case where information regarding a press conference, a homepage (HP), a new product release date, a manual, a design rule, an algorithm, a new technology, a contract, customer information, statistically processed customer information, a merger, and the like is information that may be included in the output data, by managing, for each confidentiality level, the information as the level information, only information that can be disclosed according to the confidentiality level (level) for each (attribute of) the viewer can be included in the output data.

FIG. 13 is a diagram illustrating a confidentiality level of information included in the master note mn. Since the master note mn is a note including all information, the master note mn includes strictly confidential information of the highest confidentiality level. A of FIG. 13 is a bar graph with the horizontal axis representing the confidentiality level, and indicates that the confidentiality level increases toward the right in the drawing. Furthermore, the vertical axis represents the number of times each the confidentiality levels is included in the utterance (keyword or the like) during the meeting, and indicates that the number of times increases as going upward in the drawing.

In A of FIG. 13, in a balloon, “Strictly Confidential”, “Team Confidential”, “Section Confidential”, “Department Confidential”, “Division Confidential”, “Internal Use Only”, and “Public Release” indicated in a pyramid-shaped hierarchy indicate that the confidentiality level increases as going upward, and the confidentiality level decreases as going downward. Furthermore, the confidentiality level indicated in the pyramid-shaped hierarchy corresponds to the concealment level in the bar graph. That is, since the master note mn in B of FIG. 13 is a note including all the information, the bar graph in A of FIG. 13 indicates that the information of all the confidentiality levels is included, and these pieces of information correspond to the highest confidentiality level which is “Strictly Confidential” in the pyramid-shaped hierarchy. Thus, the master note mn in B of FIG. 13 is made to be browsable only by the viewer having the attribute of being able to browse the confidentiality level which is “Strictly Confidential”.

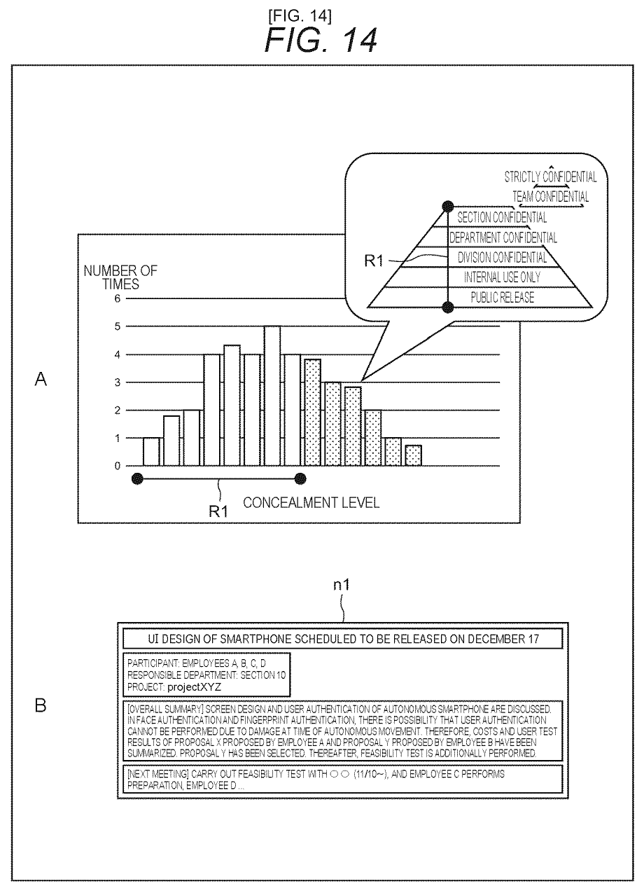

FIG. 14 is a diagram illustrating a confidentiality level of information included in the note n1. The bar graph in A of FIG. 14 indicates that the information of the confidentiality levels corresponding to the bar graphs with the dot pattern (six bar graphs on the right side) is not included in the note n1 in B of FIG. 14, and these pieces of information correspond to the upper confidentiality levels which are “Strictly Confidential” and “Team Confidential” in the pyramid-shaped hierarchy. Thus, the note n1 in B of FIG. 14 includes the information in the range (R1 in the drawing) of the confidentiality level corresponding to five hierarchies from “Public Release” to “Section Confidential”, and is made to be browsable only by the viewer having the attribute of being able to browse the information of the confidentiality level.

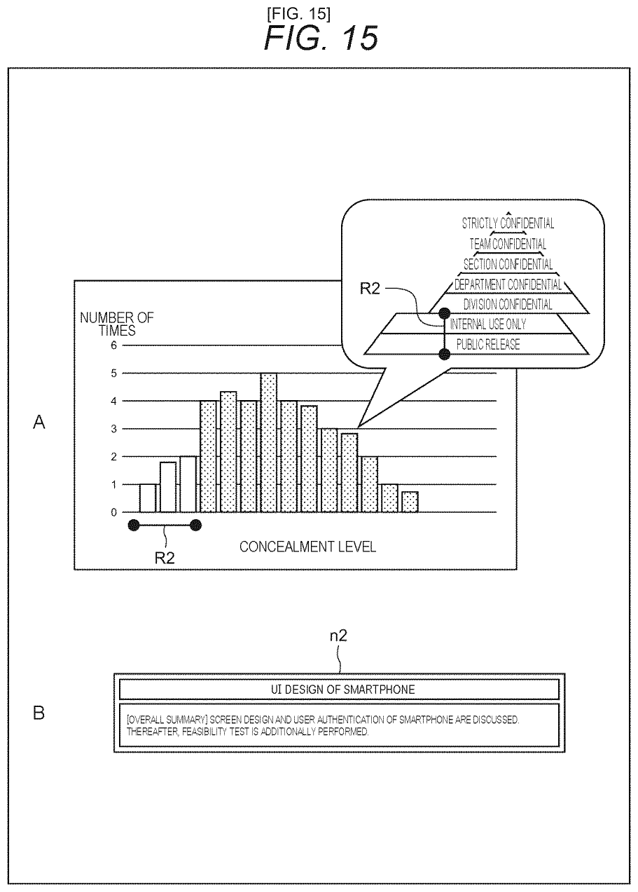

FIG. 15 is a diagram illustrating a confidentiality level of information included in the note n2. The bar graph in A of FIG. 15 indicates that the information of the confidentiality levels corresponding to the bar graphs with the dot pattern (11 bar graphs on the right side) is not included in the note n2 in B of FIG. 15, and these pieces of information correspond to five confidentiality levels from “Strictly Confidential” to “Division Confidential” in the pyramid-shaped hierarchy. Thus, the note n2 in B of FIG. 15 includes the information in the range (R2 in the drawing) of the confidentiality level corresponding to two hierarchies which are “Public Release” and “Internal Use Only”, and is made to be browsable only by the viewer having the attribute of being able to browse the information of the confidentiality level.

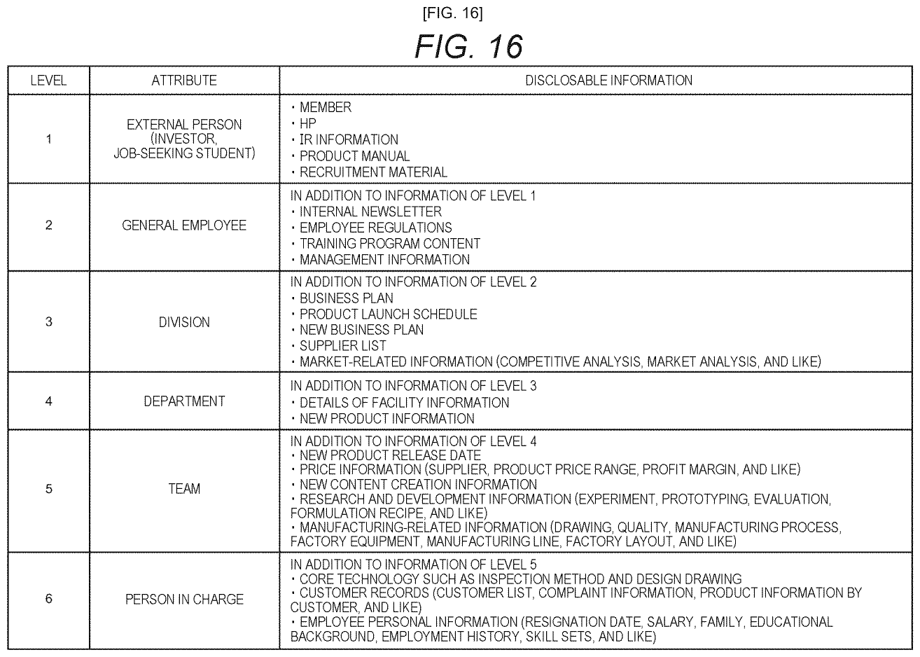

In a case where the information processing device 1 is used in the business domain, the level information stored in the level information DB 132 is, for example, information as illustrated in FIG. 16. In FIG. 16, a table indicating the level information associates the attribute with the disclosable information for each of the six levels from one to six. In FIG. 16, similarly to FIG. 8, as the numerical value indicating the level increases, the amount of disclosable information increases.

Level 1 indicates that information regarding a press conference, a homepage (HP), investigator relations (IR) information, a product manual, and recruitment materials is included as information that can be disclosed to a viewer (an investor, a job-seeking student, and the like) having an external-entity attribute (attribute indicating the viewer is an external person). Level 2 indicates that information regarding internal newsletters, employee regulations, training program content, and management information is included as information that can be disclosed to a viewer having an attribute indicating that the viewer is a general employee, in addition to the disclosable information of level 1. Level 3 indicates that information regarding a business plan, a product launch schedule, a new business plan, a supplier list, and a market-related information (competitive analysis and market analysis) is included as information that can be disclosed to a viewer having an attribute indicating a division, in addition to the disclosable information of Level 2.

Level 4 indicates that information regarding facility information details and new product information is included as information that can be disclosed to a viewer having an attribute indicating a department, in addition to the disclosable information of Level 3. Level 5 indicates that information regarding a new product release date, price information (a supplier, a product price range, a profit margin, and the like), new content creation information, research and development information (an experiment, prototyping, evaluation, formulation recipe, and the like), and manufacturing-related information (a drawing, quality, a manufacturing process, a factory equipment, a manufacturing line, a factory layout, and the like) is included as information that can be disclosed to a viewer having an attribute indicating a team, in addition to the disclosable information of Level 4. Level 6 indicates that information regarding a core technology such as an inspection method and a design drawing, customer records (a customer list, complaint information, product information by customer, and the like) and employee personal information (a resignation date, a salary, family details, educational background, employment history, skill sets, and the like) is included as information that can be disclosed to a viewer having an attribute indicating that the viewer is a person in charge, in addition to the disclosable information of Level 5.

By holding such level information, for example, in a case where a person in charge at Level 6 or a member of the team at Level 5 becomes a viewer, the master note mn (FIG. 12) is output. Furthermore, for example, in a case where a member of a department at Level 4 is a viewer, the note n1 (FIG. 12) is output as the output data, and in a case where a member of a division at Level 3 is a viewer, the note n2 (FIG. 12) is output as the output data. Note that, although not illustrated in FIG. 12, in a case where a general employee at Level 2 or an external person at Level 1 is a viewer, the note n3 (for example, only the overall summary of “A new smartphone is being developed” is included) having a narrower disclosure range is only required to be output. Note that the level information may be associated with an existing internal information DB in a company that introduces the information processing device 1.

In this manner, by outputting the output data corresponding to the level of the viewer's attribute using the level information, it is possible to provide information in a disclosable range for each viewer of the output data. For example, it is possible to share information of an appropriate level with a member who has not been able to participate in the meeting. Furthermore, it is possible to disclose what is being performed externally (outside the company) in a state where the confidentiality level is secured.

### Level Filter and Relation

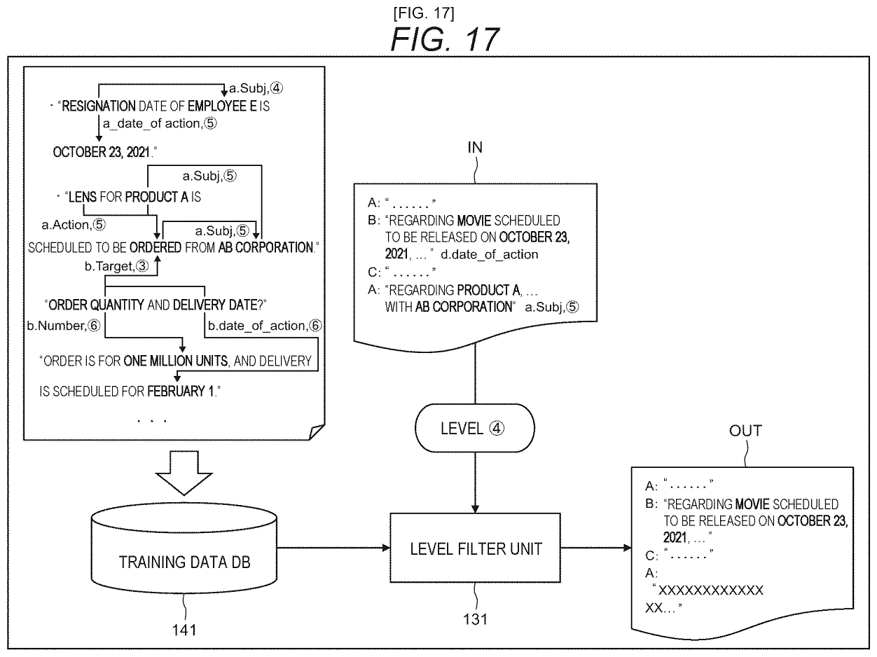

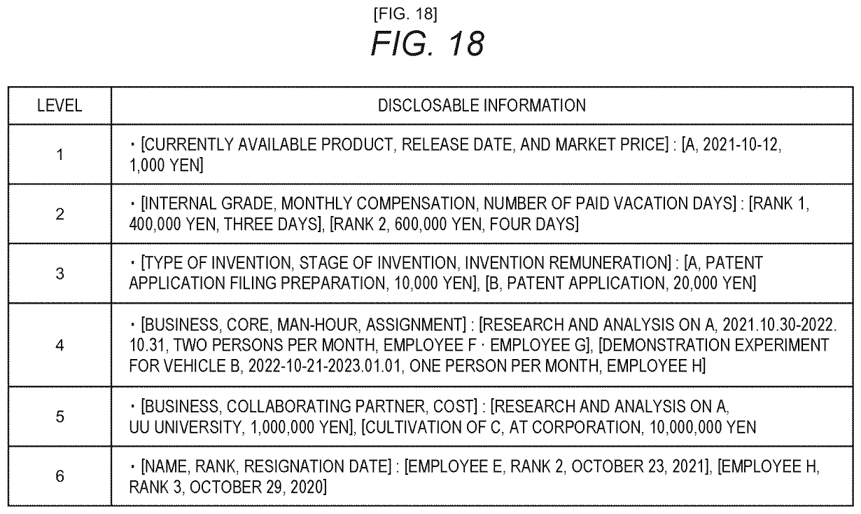

The level filter and the relation will be described with reference to FIGS. 17 and 18. FIG. 17 is a diagram illustrating a processing example of the level filter unit 131 in a case where training data is used. FIG. 18 is a diagram illustrating an example of the level information stored in the level information DB 132.

In FIG. 17, a training data DB 141 stores training data obtained by performing training using data to which a co-occurrence relation enriched with a dependency relation is annotated. For example, for the training data of “The resignation date of Employee E is October 23, 2021.”, “Resignation” is modified by “Employee E” and “October 23, 2021”, and the co-occurrence relations labeled as “a. Subj, 4” and “a. date_of_action, 5” are annotated, respectively.

Furthermore, for the training data of “The lens for Product A is scheduled to be ordered from AB Corporation.”, “Order quantity and delivery date?”, and “The order is for one million units, and the delivery is scheduled for February 1.”, “AB Corporation” is modified by “Product A”, and the co-occurrence relation labeled as “a. Subj, 5” is annotated. “Product A” and “the lens” are modified by “order”, and the co-occurrence relation labeled as “a. Action, 5” is annotated. “Order” is modified by “AB Corporation”, and the co-occurrence relation labeled as “a. Subj, 5” is annotated. “Order quantity” and “delivery date” are modified by “order”, and the co-occurrence relation labeled as “b. Target, 3” is annotated. “Order quantity” is modified by “one million units”, and the co-occurrence relation labeled as “b. Number, 6” is annotated. “Delivery date” is modified by “February 1”, and the co-occurrence relation labeled as “b. date_of_action, 6” is annotated.

At this time, when data IN is input to the level filter unit 131, disclosable information is extracted from the data IN according to the training data stored in the training data DB 141 and the level information of FIG. 18, and data OUT is output. For example, when the viewer's attribute is Level 4, the information corresponding to Levels 1 to 4 in FIG. 18 is disclosable information, but the information corresponding to Levels 5 and 6 is information that cannot be disclosed.

In FIG. 17, the data IN includes the utterance of Employee B stating “Regarding the movie scheduled to be released on Oct. 23, 2021, . . . ”, is included, but since “Oct. 23, 2021” and “the movie” are not in the co-occurrence relation annotated in the training data, the level filter unit 131 includes the utterance of the corresponding Employee B in the data OUT. Furthermore, the data IN includes the utterance of Employee A stating “Regarding Product A, . . . with ABC Corporation, . . . ”. However, the level filter unit 131 does not include the utterance of Employee A in the data OUT since “Product A” and “ABC corporation” are in the co-occurrence relation annotated in the training data, and are not the information that cannot be disclosed on the basis of the viewer's attribute. At this time, as a method without including the utterance of the corresponding Employee A in the data OUT, for example, there are the following two methods. That is, there are a method for deleting the utterance of the corresponding Employee A and a method for masking the utterance of the corresponding Employee A using the label name of the annotation and relation information. Then, the output data can be generated using the data OUT.

Incidentally, in a case where the utterance of Employee B included in the data IN includes “resignation” instead of “movie”, since “Oct. 23, 2021” and “resignation” are in a co-occurrence relation annotated in the training data, utterances related thereto is only required to be uniformly deleted in such a way as not to be included in the data OUT. In this way, for example, by uniformly deleting utterances related to a new product (for example, a portion with a dependency relation) using the training data, output data suitable for the viewer can be generated from the summary data.

As described above, by using the information processing device 1 in the business domain, at the business site, it is difficult to look back on and evaluate a dialogue that took place through interactions among multiple persons, such as a meeting, a business negotiation, and a contract and it is difficult to make improvements. However, by outputting the output data presented in a format such as a note format, a viewer can easily look back on the meeting and confirm the evaluation. When the output data is automatically output after the end of the meeting, the participant in the meeting can immediately look back on the meeting. Since the format of the information presented by the output data is well-organized, there is also an advantage that the viewer can easily view and evaluate the information. Furthermore, since the output data is generated from the summary data at the confidentiality level corresponding to the viewer's attribute using the level information, the output data including appropriate information can be output for each viewer.

### Flow of Processing

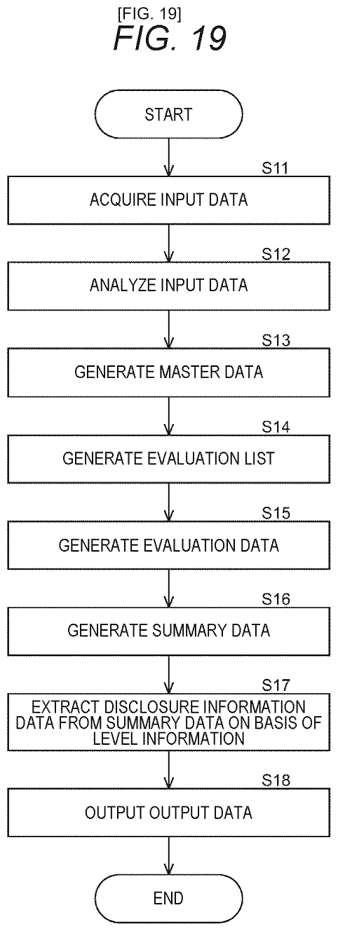

Next, a flow of processing performed by the information processing device 1 will be described with reference to a flowchart in FIG. 19.

In step S11, the acquisition unit 11 acquires input data obtained at the time of a dialogue between multiple speakers. In step S12, the analysis unit 12 performs processing, such as scene detection, utterance attitude analysis, speaker recognition, role detection, and keyword extraction, on the acquired input data and analyzes the input data.

In step S13, the master generation unit 111 generates master data on the basis of the analysis result of the input data. In step S14, the list generation unit 122 generates an evaluation list such as a communication item list on the basis of information regarding the guidelines or agenda stored in the guideline/agenda DB 123.

In step S15, the evaluation generation unit 121 evaluates the master data on the basis of the evaluation list, and generates the evaluation data according to the evaluation result. In step S16, the summary generation unit 112 generates summary data using the master data and the evaluation data on the basis of the format information stored in the format DB 113. In a case where the format information defines a predetermined note format, master note MN is generated as the summary data.

In step S17, on the basis of the level information stored in the level information DB 132, the level filter unit 131 extracts the disclosure information data from the summary data, and generates output data based on the extracted disclosure information data. The disclosure information data is data extracted from the summary data according to information in a range that can be disclosed for the viewer's attribute, the information being specified by the level information. In a case where the summary data is the master note MN in a note format, data in a note format such as the master note mn, the note n1, and the note n2 is generated as the output data according to (the level of) the viewer's attribute. In step S18, the output unit 16 outputs the output data such as the master note mn and the note n1. When step S18 ends, a series of processing ends.

The information processing device 1 configured as described above can analyze the input data regarding a dialogue between multiple speakers, generate master data to be a source for generating output data regarding the dialogue on the basis of the analysis result of the input data, generate evaluation data obtained by evaluating the master data on the basis of the evaluation metrics set in accordance with a speaker included in the multiple speakers, and generate summary data in which at least one of the master data or the evaluation data is represented in a format indicated by the format information on the basis of preset format information. Furthermore, the information processing device 1 can extract, from the summary data, the disclosure information data corresponding to the information in the disclosable range specified by the level information on the basis of the level information set according to the viewer of the output data, and output the output data based on the extracted disclosure information data. Thus, the output data including the information obtained from the dialogue can be appropriately output for each viewer of the output data.

Here, in the fields such as the educational domain and the business domain, it is difficult to look back on and evaluate the utterances in class and the dialogue that took place through interactions among multiple persons, such as a group discussion, a business negotiation, and a contract, and it is difficult to promote efficient learning and improvement. Furthermore, practical training and hands-on work, such as active learning and hands-on sales training, are said to be effective for skill improvement, but it is difficult to perform follow-up or the like after implementation. On the other hand, by using the information processing device 1 to which the present disclosure is applied in each field, it is possible to easily look back on and evaluate the dialogue and promote efficient learning and improvement, and it is also possible to facilitate the follow-up and the like after implementation in the practical training and hands-on work.

That is, by using the information processing device 1 to which the present disclosure is applied, it is possible to support objective evaluation and instruction for education and work involving interpersonal communication. Furthermore, since it is possible to present highly accurate teaching materials and instructional advice, it is possible to efficiently develop human resources by introducing the information processing device 1 to which the present disclosure is applied. Moreover, by providing the output data as the summary data in which access rights are set for each viewer, it is possible to achieve, for example, a highly transparent class or meeting.

By using the information processing device 1 to which the present disclosure is applied, it is possible to record the information regarding education and work that cannot be recorded in the related art and use the information for evaluation and follow-up. Furthermore, since it is possible to perform comparison with reference data such as past records and guidelines, it is easy for the learner to specify areas where the learner is lacking and it is possible to perform adaptive learning or the like. In the information processing device 1 to which the present disclosure is applied, it is possible to automatically generate output data without a user's operation, and thus, for example, meeting records, such as minutes, are not required and the cost of recording can be reduced. Furthermore, since the format of the information presented by the output data is organized, there is an advantage that it is easy for the viewer to visually evaluate the information, and there is an advantage that it is easy for the administrator to manage the output data.

Note that, in the above description, the educational domain and the business domain have been exemplified, but for example, a similar effect can be obtained even in a case where the information processing device 1 to which the present disclosure is applied is used in other fields such as medical care, nursing care, and childcare. However, it is necessary to store information corresponding to the field to be used in the databases such as the guideline/agenda DB 123, the support information DB 124, and the level information DB 132. That is, when information corresponding to various fields is stored in advance in the database, it is possible to sequentially generate the master data, the evaluation data, and the summary data using the input data regardless of the field, and finally present the output data corresponding to the viewer's attribute (confidentiality level). Note that the data generated by the information processing device 1 to which the present disclosure is applied may be used when the training data is accumulated as a portfolio.

### Modification Example

### <<Data Processing Flow>>

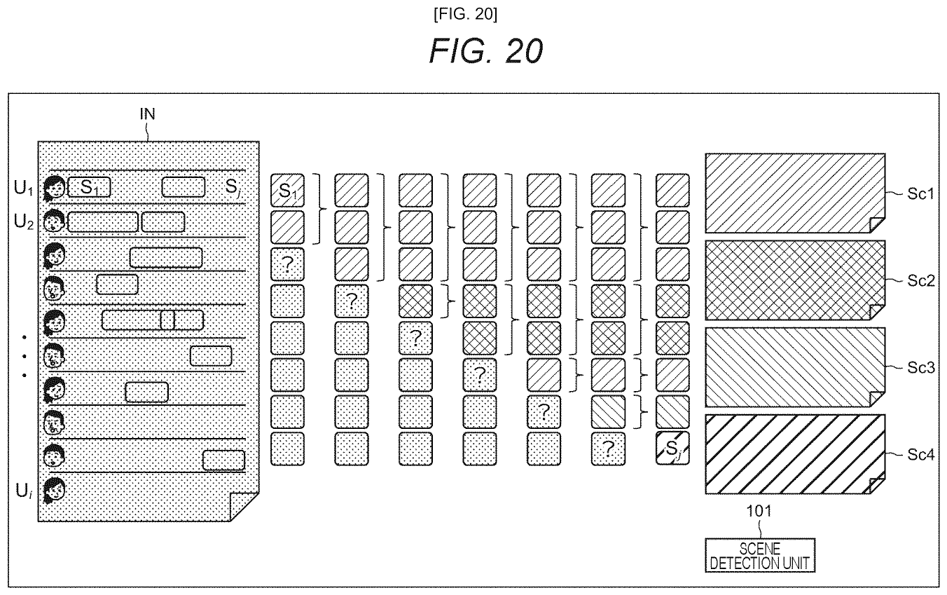

FIG. 20 illustrates how scenes are classified at the sentence level of utterances by the scene detection unit 101 in the analysis unit 12 as another example of a data processing flow in the information processing device 1. In FIG. 20, when the input data IN including data of utterance (U) of each speaker is input to the scene detection unit 101, each utterance includes multiple sentences (S). For example, when data of utterances U₁ to Uᵢ is input, sentences S₁ to Sⱼ are included in the utterance U₁ (i and j are integers of two or more).

At this time, mapping is performed on the scene Sc for each sentence S, and a pattern assigned to a small square having a square shape representing the sentence S and a pattern assigned to a large square having a rectangular shape representing the scene Sc correspond to each other, and it is indicated that the small square and the large square, which have a common pattern, are mapped. For example, in the utterance U₁, sentences S₁ to S₃ are mapped to the scene Sc1, and sentences S₄ and S₅ are mapped to the scene Sc2. Furthermore, sentence S₆ is mapped to the scene Sc1, and sentence S₇ is mapped to the scene Sc3.

Here, by processing each sentence by natural language processing, for example, in a case where it is detected that the topic is changed between the sentence S₃ and the sentence S₄, the sentence S₄ is mapped not to the scene Sc1 but to the scene Sc2. Furthermore, in a case where it is detected that the topic is changed between the sentence S₅ and the sentence S₆, the sentence S₆ is mapped not to the scene Sc2 but to the scene Sc1. As a case of mapping the sentence Se to the scene Sc1, for example, a case is assumed where, as the utterance of a teacher in class, greetings (sentences S₁ to S₃) are first performed (scene Sc1), and then the class is started (scene Sc2), but greeting (sentence S₆) is performed to a student who enters the class late. Such greeting (sentence S₆) to the late student is classified into a scene of the opening greeting (scene Sc1), instead of a scene in class (scene Sc2) or a new scene (scene Sc3 or the like).

As described above, the scene detection unit 101 can more appropriately detect each scene by analyzing the utterance of the speaker at the sentence level, searching for which scene the utterance belongs at the sentence level, and mapping the utterance to the scene. At this time, when the topic is changed between the sentences, and it is correct to map not only the sentence to the new scene, but also the sentence to the already detected scene, it is also possible to map the sentence to the already detected scene.

### <<Other Configurations>>

In FIG. 1, the configuration in which the information processing device 1 includes the acquisition unit 11, the analysis unit 12, the generation unit 13, the evaluation/support output unit 14, the output adjustment unit 15, and the output unit 16 has been illustrated. However, the information processing device 1 is not limited to be configured as one device, and may be configured as a system in which multiple devices including at least one block is provided. For example, an information processing system can be configured to include a first device including the acquisition unit 11, a second device including the analysis unit 12, the generation unit 13, the evaluation/support output unit 14, and the output adjustment unit 15, and a third device including the output unit 16. The system refers to a logical assembly of multiple devices.

Furthermore, in the information processing device 1, the databases such as the format DB 113, the guideline/agenda DB 123, the support information DB 124, and the level information DB 132 are recorded in a storage unit including a hard disk drive (HDD) and a solid state drive (SSD), but may be provided by an external storage device, a database (DB) server on a network such as the Internet, or the like. In a case where the information processing device 1 includes a communication I/F and can be connected to the Internet, at least some of the functions of the analysis unit 12, the generation unit 13, the evaluation/support output unit 14, or the output adjustment unit 15 may be provided by a cloud server. The analysis unit 12 is not limited to the scene detection, the utterance attitude analysis, the speaker recognition, the role detection, and the keyword extraction, and may perform other analysis processing as long as the information regarding the dialogue between multiple speakers can be obtained.

In a case where the output data is data in a note format, the output data includes information of text and an image, but is not limited to the text and the image, and may include other information such as audio and a moving image. In the information processing device 1, the output unit 16 is not limited to a display and a communication I/F, and may include a speaker.

### <Configuration of Computer>

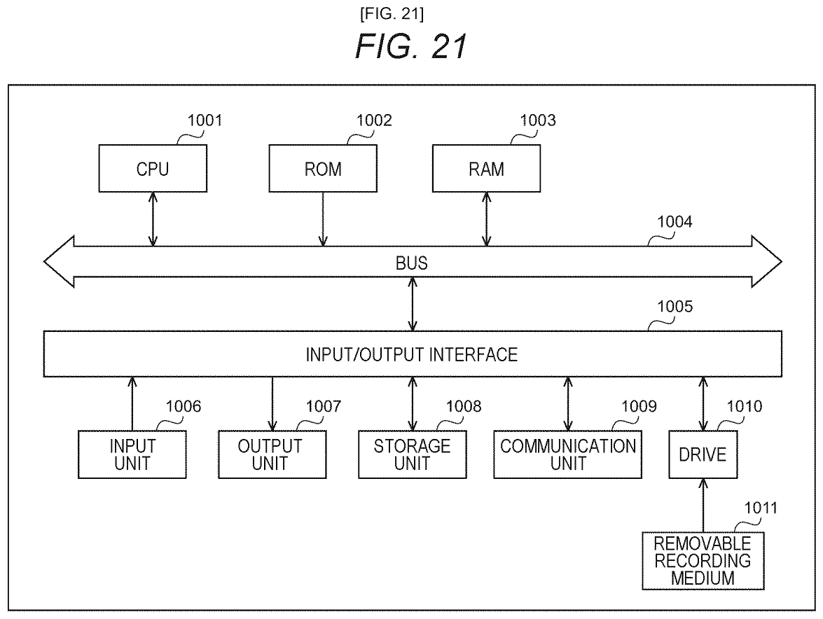

The above-described series of processing can be executed by hardware or can be executed by software. In a case where the series of processing is executed by software, a program constituting the software is installed in a computer. FIG. 21 is a block diagram illustrating a configuration example of the hardware of the computer that executes the above-described series of processing by the program.

In the computer, a central processing unit (CPU) 1001, a read only memory (ROM) 1002, and a random access memory (RAM) 1003 are mutually connected by a bus 1004.

The CPU 1001 is an example of a processor, and may use another processor such as a graphics processing unit (GPU). The number of processors is not limited to one, and multiple processors may be provided. An input/output interface 1005 is further connected to the bus 1004. An input unit 1006, an output unit 1007, a storage unit 1008, a communication unit 1009, and a drive 1010 are connected to the input/output interface 1005.

The input unit 1006 includes a keyboard, a mouse, and a microphone. The output unit 1007 includes a display and a speaker. The storage unit 1008 includes a hard disk and a nonvolatile memory. The communication unit 1009 includes a network interface. The drive 1010 drives a removable recording medium 1011 such as a semiconductor memory, a magnetic disk, an optical disk, or a magneto-optical disk.

In the computer configured as described above, the CPU 1001 loads a program recorded in the ROM 1002 or the storage unit 1008 into the RAM 1003 via the input/output interface 1005 and the bus 1004 and executes the program, and thus the above-described series of processing is performed.

For example, the program executed by the computer (CPU 1001) can be provided by being recorded in the removable recording medium 1011 as a package medium or the like. Furthermore, the program can be provided via a wired or wireless transmission medium such as a local area network, the Internet, or digital satellite broadcasting.

In the computer, the program can be installed in the storage unit 1008 via the input/output interface 1005 by attaching the removable recording medium 1011 to the drive 1010. Furthermore, the program can be received by the communication unit 1009 via a wired or wireless transmission medium and installed in the storage unit 1008. In addition, the program can be installed in the ROM 1002 or the storage unit 1008 in advance.

The processing performed by the computer according to the program also includes processing executed in parallel or individually (for example, parallel processing or processing by an object). Furthermore, the program may be processed by one computer (processor) or may be processed in a distributed manner by multiple computers.

Note that the embodiments of the present disclosure are not limited to the above-described embodiments, and various modifications can be made without departing from the gist of the present disclosure. Furthermore, the effects described in the present specification are merely examples and are not limited, and other effects may be provided.

Furthermore, the present disclosure can have the following configurations.

(1)

An information processing device including:
an analysis unit that analyzes input data regarding a dialogue between multiple speakers;
a master generation unit that generates master data serving as a source for generating output data regarding the dialogue on the basis of an analysis result of the input data;
an evaluation generation unit that generates evaluation data obtained by evaluating the master data on the basis of evaluation metrics set in accordance with a speaker included in the multiple speakers;
a summary generation unit that generates summary data representing at least one of the master data or the evaluation data in a format indicated by format information on the basis of preset format information; and
a filter unit that extracts, from the summary data, disclosure information data corresponding to information in a disclosable range designated by level information on the basis of the level information set in accordance with a viewer of the output data, and outputs the output data based on the extracted disclosure information data.
   (2)

The information processing device according to (1), further including a list generation unit that generates an evaluation list for evaluating the dialogue on the basis of evaluation metric source information serving as a source of a metric when the dialogue is evaluated, in which
the evaluation generation unit evaluates the master data on the basis of the evaluation list and generates the evaluation data corresponding to an evaluation result.
   (3)

The information processing device according to (2), in which
the evaluation list includes an evaluation item corresponding to at least one of a communication item to be conveyed in the dialogue, a question item to be asked, or a confirmation item to be confirmed, and
in a case where information regarding the evaluation item is included in information regarding the dialogue included in the master data, the evaluation generation unit evaluates the corresponding information regarding the dialogue higher than the information regarding the dialogue not including the information regarding the evaluation item.
   (4)

The information processing device according to (3), in which
the evaluation metric source information includes a guideline or agenda prepared for each field of the dialogue.
   (5)

The information processing device according to (1), in which
the level information defines information in a disclosable range for each attribute corresponding to a confidentiality level, and
the filter unit extracts, from the summary data, the disclosure information data corresponding to the information in the disclosable range for the viewer's attribute, and generates the output data based on the extracted disclosure information data.
   (6)

The information processing device according to (5), in which
the level information includes a first level indicating first confidentiality and a second level indicating second confidentiality higher than the first confidentiality, and
in a case where a first viewer having a first attribute corresponding to the first level browses the output data, the filter unit adjusts an information amount of the output data based on the disclosure information data extracted from the summary data such that an amount of information browsable by the first viewer is reduced as compared with a case where a second viewer having a second attribute corresponding to the second level browses the output data.
   (7)

The information processing device according to (5) or (6), in which
the output data has an information amount smaller than that of the summary data.
   (8)

The information processing device according to any one of (1) to (5), in which
the analysis unit performs scene detection processing of detecting each scene of the dialogue on the input data, and analyzes an utterance of a speaker included in the multiple speakers for each detected scene.
   (9)

The information processing device according to (8), in which
the analysis unit performs, for each detected scene, utterance attitude analysis processing of analyzing an attitude of an utterance by the speaker, speaker identification processing of identifying the speaker, role detection processing of detecting a role of the speaker, and keyword detection processing of extracting a specific keyword included in the utterance of the speaker.
   (10)

The information processing device according to any one of (1) to (5), in which
the format information includes a note format in which information is organized for each of various items, and
the summary data and the output data are represented in the note format.
   (11)

The information processing device according to any one of (1) to (5), further including an acquisition unit that acquires the input data, in which
the input data includes text data obtained by converting audio data related to the dialogue captured by a microphone.
   (12)

The information processing device according to any one of (1) to (5), further including an output unit that outputs the output data, in which
the output data includes at least text data corresponding to the disclosure information data.
   (13)

An information processing method including:
by an information processing device,
analyzing input data regarding a dialogue between multiple speakers;
generating master data serving as a source for generating output data regarding the dialogue on the basis of an analysis result of the input data;
generating evaluation data obtained by evaluating the master data on the basis of evaluation metrics set in accordance with a speaker included in the multiple speakers;
generating summary data representing at least one of the master data or the evaluation data in a format indicated by format information on the basis of preset format information; and
extracting, from the summary data, disclosure information data corresponding to information in a disclosable range designated by level information on the basis of the level information set in accordance with a viewer of the output data, and outputting the output data based on the extracted disclosure information data.
   (14)

A program that causes a computer to function as:
an analysis unit that analyzes input data regarding a dialogue between multiple speakers;
a master generation unit that generates master data serving as a source for generating output data regarding the dialogue on the basis of an analysis result of the input data;
an evaluation generation unit that generates evaluation data obtained by evaluating the master data on the basis of evaluation metrics set in accordance with a speaker included in the multiple speakers;
a summary generation unit that generates summary data representing at least one of the master data or the evaluation data in a format indicated by format information on the basis of preset format information; and
a filter unit that extracts, from the summary data, disclosure information data corresponding to information in a disclosable range designated by level information on the basis of the level information set in accordance with a viewer of the output data, and outputs the output data based on the extracted disclosure information data.

### REFERENCE SIGNS LIST

1 Information processing device
11 Acquisition unit
12 Analysis unit
13 Generation unit
14 Evaluation/support output unit
15 Output adjustment unit
16 Output unit
101 Scene detection unit
102 Utterance attitude analysis unit
103 Speaker recognition unit
104 Role detection unit
105 Keyword extraction unit
111 Master generation unit
112 Summary generation unit
113 Format DB
121 Evaluation generation unit
122 List generation unit
123 Guideline/agenda DB
124 Support information DB
131 Level filter unit
132 Level information DB
141 Training data DB
1001 CPU

1. An information processing device comprising:
an analysis unit that analyzes input data regarding a dialogue between multiple speakers;
a master generation unit that generates master data serving as a source for generating output data regarding the dialogue on a basis of an analysis result of the input data;
an evaluation generation unit that generates evaluation data obtained by evaluating the master data on a basis of evaluation metrics set in accordance with a speaker included in the multiple speakers;
a summary generation unit that generates summary data representing at least one of the master data or the evaluation data in a format indicated by format information on a basis of preset format information; and
a filter unit that extracts, from the summary data, disclosure information data corresponding to information in a disclosable range designated by level information on a basis of the level information set in accordance with a viewer of the output data, and outputs the output data based on the extracted disclosure information data.

2. The information processing device according to claim 1, further comprising a list generation unit that generates an evaluation list for evaluating the dialogue on a basis of evaluation metric source information serving as a source of a metric when the dialogue is evaluated, wherein
the evaluation generation unit evaluates the master data on a basis of the evaluation list and generates the evaluation data corresponding to an evaluation result.

3. The information processing device according to claim 2, wherein
the evaluation list includes an evaluation item corresponding to at least one of a communication item to be conveyed in the dialogue, a question item to be asked, or a confirmation item to be confirmed, and
in a case where information regarding the evaluation item is included in information regarding the dialogue included in the master data, the evaluation generation unit evaluates the corresponding information regarding the dialogue higher than the information regarding the dialogue not including the information regarding the evaluation item.

4. The information processing device according to claim 3, wherein
the evaluation metric source information includes a guideline or agenda prepared for each field of the dialogue.

5. The information processing device according to claim 1, wherein
the level information defines information in a disclosable range for each attribute corresponding to a confidentiality level, and
the filter unit extracts, from the summary data, the disclosure information data corresponding to the information in the disclosable range for the viewer's attribute, and generates the output data based on the extracted disclosure information data.

6. The information processing device according to claim 5, wherein
the level information includes a first level indicating first confidentiality and a second level indicating second confidentiality higher than the first confidentiality, and
in a case where a first viewer having a first attribute corresponding to the first level browses the output data, the filter unit adjusts an information amount of the output data based on the disclosure information data extracted from the summary data such that an amount of information browsable by the first viewer is reduced as compared with a case where a second viewer having a second attribute corresponding to the second level browses the output data.

7. The information processing device according to claim 5, wherein
the output data has an information amount smaller than that of the summary data.

8. The information processing device according to claim 1, wherein
the analysis unit performs scene detection processing of detecting each scene of the dialogue on the input data, and analyzes an utterance of a speaker included in the multiple speakers for each detected scene.

9. The information processing device according to claim 8, wherein
the analysis unit performs, for each detected scene, utterance attitude analysis processing of analyzing an attitude of an utterance by the speaker, speaker identification processing of identifying the speaker, role detection processing of detecting a role of the speaker, and keyword detection processing of extracting a specific keyword included in the utterance of the speaker.

10. The information processing device according to claim 1, wherein
the format information includes a note format in which information is organized for each of various items, and
the summary data and the output data are represented in the note format.

11. The information processing device according to claim 1, further comprising an acquisition unit that acquires the input data, wherein
the input data includes text data obtained by converting audio data related to the dialogue captured by a microphone.

12. The information processing device according to claim 1, further comprising an output unit that outputs the output data, wherein
the output data includes at least text data corresponding to the disclosure information data.

13. An information processing method comprising:
by an information processing device,
analyzing input data regarding a dialogue between multiple speakers;
generating master data serving as a source for generating output data regarding the dialogue on a basis of an analysis result of the input data;
generating evaluation data obtained by evaluating the master data on a basis of evaluation metrics set in accordance with a speaker included in the multiple speakers;
generating summary data representing at least one of the master data or the evaluation data in a format indicated by format information on a basis of preset format information; and
extracting, from the summary data, disclosure information data corresponding to information in a disclosable range designated by level information on a basis of the level information set in accordance with a viewer of the output data, and outputting the output data based on the extracted disclosure information data.

14. A program that causes a computer to function as:
an analysis unit that analyzes input data regarding a dialogue between multiple speakers;
a master generation unit that generates master data serving as a source for generating output data regarding the dialogue on a basis of an analysis result of the input data;
an evaluation generation unit that generates evaluation data obtained by evaluating the master data on a basis of evaluation metrics set in accordance with a speaker included in the multiple speakers;
a summary generation unit that generates summary data representing at least one of the master data or the evaluation data in a format indicated by format information on a basis of preset format information; and
a filter unit that extracts, from the summary data, disclosure information data corresponding to information in a disclosable range designated by level information on a basis of the level information set in accordance with a viewer of the output data, and outputs the output data based on the extracted disclosure information data.
